(19) United States
(12) Patent Application Publication
(10) Pub. No.: US 2026/0289689 A1
(43) Pub. Date: Sep. 24, 2026

(54) SYSTEM

(71) Applicant: SoftBank Group Corp., Tokyo (JP)

(72) Inventor: Kenichi MIYATA, Tokyo (JP)

(73) Assignee: SoftBank Group Corp., Tokyo (JP)

(21) Appl. No.: 19/566,991

(22) Filed: Mar. 14, 2026

(30) Foreign Application Priority Data
Mar. 19, 2025 (JP) 2025-045100

(51) Int. Cl. G06Q 40/12; G06F 40/40; G06V 10/25; G06V 10/26; G06V 10/30; G06V 10/72; G06V 10/764; G06V 10/776; G06V 10/82; G06V 30/148; G06V 30/16; G06V 30/164; G06V 30/19

(52) U.S. Cl. CPC G06Q 40/123; G06F 40/40; G06V 10/25; G06V 10/26; G06V 10/30; G06V 10/72; G06V 10/764; G06V 10/776; G06V 10/82; G06V 30/153; G06V 30/1607; G06V 30/164; G06V 30/1916; G06V 30/19173

(57) ABSTRACT

A system includes a processor that is configured to receive, via a communication application, an image of a transaction document and perform preprocessing on the image by using an image processing technique, extract text information from the preprocessed image by using a character recognition technique, generate, based on the extracted text information, a prompt for instructing a generative AI model to execute an accounting process, input the generated prompt into the generative AI model to generate accounting data, and record the generated accounting data in a database and convert the generated accounting data into a tax filing format.

### CROSS-REFERENCE TO RELATED APPLICATION

This application is based on and claims priority under 35 USC 119 from Japanese Patent Application No. 2025-045100 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional accounting systems and tax filing support tools require users to perform numerous manual operations, including manual input of transaction details from receipts and invoices, manual classification of transactions into accounting categories, and manual transposition of accounting data into tax filing formats. Even when optical character recognition (OCR) and basic automation tools are used, users are still required to confirm and correct extracted data through complex user interfaces and specialized accounting screens, which are not intuitive for users who lack expert knowledge in bookkeeping or tax law. Furthermore, existing systems provide limited integration between automated data extraction and modern generative AI models, making it difficult to flexibly interpret semi-structured or unstructured information contained in transaction documents. In addition, users who wish to correct or update accounting data or seek tax-related advice must often rely on separate tools, manual communication with experts, or rigid rule-based systems that do not understand natural language instructions with sufficient flexibility. As a result, there exists a need for a system that seamlessly receives transaction document images via everyday communication applications, automatically extracts and interprets text information, generates appropriate prompts for a generative AI model to perform accounting processes, converts resulting accounting data into tax filing formats, and further enables natural language interaction for data correction and expert-level advice, thereby significantly reducing the burden on users and improving accuracy and efficiency of accounting and tax filing operations.

### SUMMARY

In order to solve the above-described problems, the present invention provides a system comprising a processor, wherein the processor is configured to receive, via a communication application, an image of a transaction document and perform preprocessing on the image by using an image processing technique, extract text information from the preprocessed image by using a character recognition technique, generate, based on the extracted text information, a prompt for instructing a generative AI model to execute an accounting process, input the generated prompt into the generative AI model to generate accounting data, and record the generated accounting data in a database and convert the generated accounting data into a tax filing format. The processor is further configured to provide an interface for allowing a user to input an instruction in natural language, analyze the instruction by using a natural language processing technique, generate a prompt for instructing the generative AI model to automatically modify the accounting data, and input the prompt into the generative AI model, thereby enabling the user to update or correct accounting data through natural language interaction without requiring specialized accounting operations. Moreover, the processor is configured to generate a prompt for instructing the generative AI model to cooperate with an external expert system and provide appropriate advice based on the generated accounting data, and input the prompt into the generative AI model, thereby allowing the user to obtain expert-level tax and accounting advice within the same communication application environment. Through these means, the system of the present invention achieves integrated automation of data capture, accounting processing, tax-format conversion, natural language-based correction, and expert advice provision.

The term “processor” refers to one or more hardware processors, processing circuits, or computing units, which may operate alone or in combination, and which are configured to execute instructions to perform the functions described in the claims.

The term “communication application” refers to a software application or service that enables exchange of messages, images, or other data between a user and a server over a network, including but not limited to messenger applications, chat applications, email applications, and similar communication platforms.

The term “transaction document” refers to any document that evidences a financial or commercial transaction, including but not limited to receipts, invoices, bills, vouchers, statements, and similar documents containing transaction-related information.

The term “image of a transaction document” refers to digital image data representing at least a part of a transaction document, including photographs captured by a camera, scanned images, screenshots, or other raster or vector image formats.

The term “image processing technique” refers to any computational method or algorithm applied to digital image data for preprocessing, including but not limited to resizing, noise reduction, binarization, contrast enhancement, skew correction, cropping, and segmentation. The term “preprocessing” refers to a series of image processing operations applied to an image prior to character recognition, in order to improve the quality of the image and the accuracy of subsequent text extraction.

The term “character recognition technique” refers to optical character recognition (OCR) or similar technologies that analyze an image and output text data corresponding to characters, numbers, symbols, or other textual elements contained in the image.

The term “text information” refers to alphanumeric characters, symbols, and other textual content extracted from an image of a transaction document, including but not limited to dates, amounts, vendor names, item descriptions, and tax-related information.

The term “prompt” refers to a structured or semi-structured input, including natural language text, instructions, parameters, or templates, that is supplied to a generative AI model to cause the model to perform a specific processing operation or generate a desired output.

The term “generative AI model” refers to an artificial intelligence model, such as a large language model or other generative model, that is trained on large-scale data and is capable of generating text, structured data, or other outputs in response to a given prompt.

The term “accounting process” refers to any processing related to bookkeeping or accounting, including but not limited to classification of transactions, determination of accounting categories, generation of journal entries, calculation of totals, and preparation of accounting records.

The term “accounting data” refers to data representing the results of accounting processes, including but not limited to journal entries, account codes, categories, amounts, dates, tax classifications, and other structured financial information.

The term “database” refers to any data storage system, including relational databases, NoSQL databases, or other persistent storage mechanisms, that is configured to store, retrieve, and manage accounting data and related information.

The term “tax filing format” refers to a data format or structure that conforms to requirements for tax returns or tax declarations, including but not limited to government-prescribed electronic formats, standardized forms, and internal representations aligned with such formats.

The term “interface” refers to a user-accessible component, such as a graphical user interface, chat interface, input field, or API endpoint, that allows a user to input instructions or receive outputs from the system.

The term “instruction in natural language” refers to a command, request, or query expressed in a human language, such as English or Japanese, without requiring a predefined command syntax or programming language.

The term “natural language processing technique” refers to any algorithm or model for processing natural language, including but not limited to tokenization, parsing, intent detection, entity extraction, and semantic analysis.

The term “automatically modify the accounting data” refers to changing, updating, or correcting accounting data by computational means in response to a user instruction and without requiring manual editing of individual accounting fields by the user.

The term “external expert system” refers to a system external to the claimed system that has domain-specific knowledge or rule bases, such as a tax expert system, an accounting expert system, or a specialized advisory engine, and is capable of providing expert advice or evaluations.

The term “appropriate advice” refers to guidance, recommendations, explanations, or evaluations related to accounting or tax matters, which are generated based on accounting data and expert knowledge to support user decision-making or compliance.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

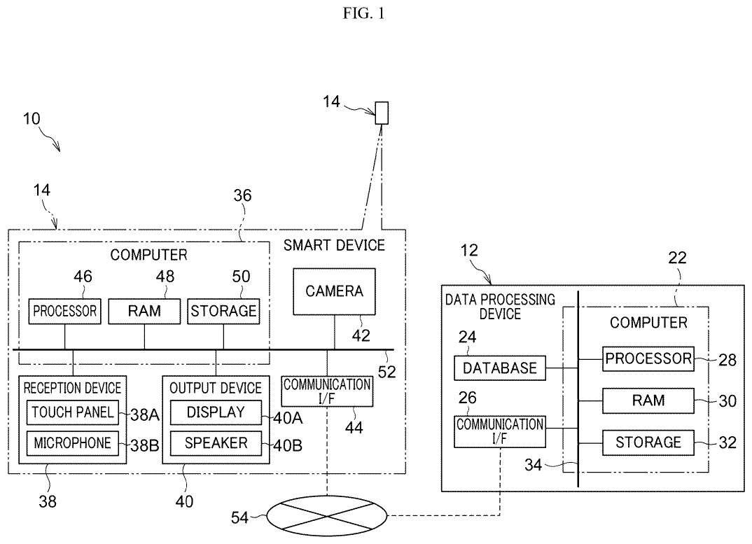

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

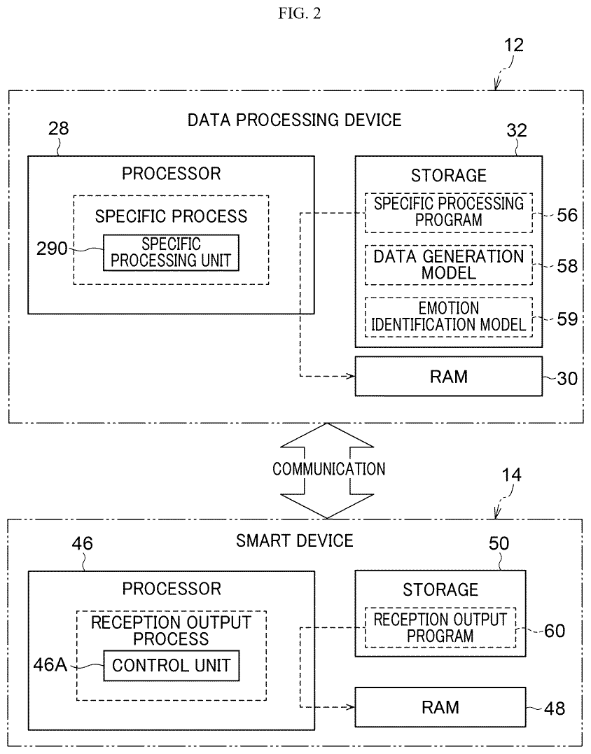

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented accounting systems that process transaction vouchers suffer from several technical limitations in how they acquire, structure, and utilize voucher information. In many existing systems, image data of vouchers is merely stored or subjected to simple optical character recognition, and subsequent interpretation, classification, and correction rely heavily on manual operations or rigid rule sets. As a result, the overall processing pipeline from raw image acquisition to final accounting records and tax filing data is fragmented, error-prone, and difficult to scale.

First, with respect to image handling, typical systems apply only basic transformations and do not perform context-aware preprocessing optimized for downstream character recognition.

This leads to unstable character recognition accuracy under real-world conditions such as noise, skew, distortion, and poor lighting. The computer resources are thus inefficiently utilized because repeated manual correction of recognition errors is required, and the throughput of automated processing is constrained.

Second, with respect to data structuring, many systems treat OCR output as flat text and lack a robust mechanism for converting the text into structured fields such as transaction date, amount, counterpart, content, and tax category in a consistent manner. Without reliable structuring and validation at the system level, the subsequent accounting processing cannot be fully automated, and the computer must rely on hard-coded rules that are brittle and difficult to maintain.

Third, with respect to accounting processing, conventional systems either apply fixed accounting rules or require manual selection of account classifications. Such approaches do not leverage generative artificial intelligence capabilities to interpret context and flexibly generate accounting information such as account classifications, debit and credit classifications, and amounts. Consequently, the computer system is not able to automatically adapt to diverse voucher formats, new transaction types, or user-specific accounting practices without extensive reprogramming.

Fourth, with respect to user interaction and correction, many systems do not provide a unified natural language interface that directly drives database queries and corrections through a machine-understandable representation. Users must learn specialized user interfaces or codes, and the computer must implement multiple separate interaction layers, which increases complexity. Furthermore, the lack of integrated prompt generation and logging makes it difficult for the system to manage, trace, and reproducibly adjust the behavior of generative artificial intelligence components.

Fifth, with respect to integration with external expert resources, existing systems typically call external expert systems in an ad-hoc manner, without a systematic, prompt-driven coordination between internal structured data and external knowledge processing. This results in non-uniform advice quality and complicates the flow of information between the accounting core and advisory components, thereby limiting the effectiveness of the overall computer system for tax and compliance tasks.

Accordingly, there is a need for a computer-implemented system that technically improves the entire processing pipeline by: (i) performing structured and validation-aware preprocessing of voucher images; (ii) converting verified character information into machine-usable structured information; (iii) generating prompt sentences to systematically instruct a generative information processing model to produce accounting data; (iv) storing and managing the resulting accounting data with transaction-controlled consistency and explicit linkage to original images and prompts; and (v) enabling natural language-based search, correction, and expert cooperation through coordinated prompt generation. Such a system should enhance the reliability, scalability, and efficiency of the underlying computer operations themselves, rather than merely automating a business workflow at a superficial level.

The specific processing by the specific processing unit 290 of the data processing device 12 in Example 1 is realized by the following means.

The present invention provides a server comprising a processor configured to receive image information of an information recording medium via a communication processing device; to perform preprocessing on the image information by using an image processing technique including at least noise removal, resolution adjustment, density correction, binarization, and geometric correction; to extract character information from the preprocessed image information by using a character recognition technique and perform verification processing on the character information including at least format determination, numerical value determination, date determination, and misrecognition correction; to generate structured information indicating at least a transaction date, a transaction amount, a transaction counterpart, a transaction content, and a tax category on the basis of the character information after the verification processing; to generate a prompt sentence for instructing a generative information processing model to automatically generate accounting information including at least an account classification, a debit classification, a credit classification, and an amount on the basis of the structured information and accounting rule information; to input the prompt sentence and the structured information into the generative information processing model and acquire, from the generative information processing model, accounting data including accounting journal information and correction history information associated with the accounting journal information; to store the accounting data in an information management device and convert the accounting data into declaration data corresponding to a taxation procedure format while maintaining consistency by transaction control; and to record, as identification information, a correspondence among the accounting data, the image information of the information recording medium, and the prompt sentence, and to enable, in subsequent inquiry or correction processing, acquisition of the accounting data, the image information, and the prompt sentence in association with one another on the basis of the identification information. This enables improvement of the technical operation of the computer system by providing an integrated, prompt-driven processing pipeline from image acquisition to structured accounting and tax data, reducing recognition errors, enhancing data consistency and traceability, and allowing natural language interaction and generative model cooperation to be executed as controlled, verifiable computer processes.

The term “processor” refers to a hardware or virtual processing unit, such as a central processing unit or a logical processing core, that executes instructions to implement the functions described in the system.

The term “communication processing device” refers to a hardware or software component, such as a network interface controller, communication module, or communication service, that transmits and receives data between the system and an external device over a communication network.

The term “information recording medium” refers to a physical or electronic medium on which transaction-related information is recorded, including but not limited to vouchers, receipts, invoices, and other documents that prove a transaction.

The term “image information” refers to digital data representing an image, such as a bitmap, raster data, or compressed image file, obtained by capturing or scanning an information recording medium.

The term “image processing technique” refers to a computational method that operates on image information to modify, enhance, or analyze pixel values, including operations such as noise removal, resolution adjustment, density correction, binarization, and geometric correction.

The term “noise removal” refers to image processing that reduces or eliminates random variations or unwanted artifacts in pixel values in order to improve the clarity and recognizability of image content.

The term “resolution adjustment” refers to processing that changes the spatial resolution of image information by resizing or resampling the image.

The term “density correction” refers to processing that adjusts brightness, contrast, or tonal distribution of an image to improve visibility of characters or features.

The term “binarization” refers to processing that converts image information into two-level data, typically foreground and background, based on a threshold or adaptive thresholding method.

The term “geometric correction” refers to processing that corrects distortions or misalignments in image geometry, such as skew, rotation, or perspective distortion, to align the content into a desired orientation.

The term “character recognition technique” refers to a computational method, including optical character recognition, that analyzes image information to detect and convert characters or symbols into digital character codes.

The term “character information” refers to digital representations of characters, symbols, or strings obtained by applying a character recognition technique to image information.

The term “verification processing” refers to a set of operations that evaluate and correct character information, including checking conformity to expected formats, validating numerical values and dates, and correcting likely recognition errors.

The term “format determination” refers to processing that determines whether a string of character information matches an expected pattern, such as a date format, currency format, or identifier format.

The term “numerical value determination” refers to processing that identifies and validates numeric values within character information, including amounts and quantities.

The term “date determination” refers to processing that identifies, parses, and validates date expressions within character information.

The term “misrecognition correction” refers to processing that detects and corrects likely character recognition errors using rules, dictionaries, or contextual information.

The term “structured information” refers to data in which individual elements, such as transaction date, transaction amount, transaction counterpart, transaction content, and tax category, are explicitly separated and represented according to a predefined schema.

The term “transaction date” refers to structured information indicating a date on which a transaction associated with an information recording medium occurred.

The term “transaction amount” refers to structured information indicating a monetary value associated with a transaction recorded on an information recording medium.

The term “transaction counterpart” refers to structured information indicating an entity, such as a business or individual, that is a party to the transaction associated with an information recording medium.

The term “transaction content” refers to structured information indicating the nature, purpose, or description of goods or services involved in a transaction.

The term “tax category” refers to structured information indicating a classification of a transaction for taxation purposes, such as taxable, non-taxable, or tax-exempt categories.

The term “accounting rule information” refers to data defining rules and conditions used for accounting processing, including mappings between transaction attributes and account classifications, debit and credit logic, and tax-related rules.

The term “prompt sentence” refers to a sequence of symbols in a natural or formal language that is input to a generative information processing model to instruct the model to perform a specific processing task.

The term “generative information processing model” refers to a computational model, such as a generative artificial intelligence model or language model, that generates output data, including structured accounting information, in response to input data including prompt sentences.

The term “accounting information” refers to data indicating accounting-related classifications and values, including account classifications, debit classifications, credit classifications, and amounts, suitable for recording in an accounting system.

The term “account classification” refers to a label or code identifying a type of account used in accounting, such as an expense, revenue, asset, liability, or equity category.

The term “debit classification” refers to information indicating an account or category to which a debit entry is applied in a journal entry.

The term “credit classification” refers to information indicating an account or category to which a credit entry is applied in a journal entry.

The term “accounting data” refers to a collection of data generated by the system, including accounting journal information and associated correction history information, which can be stored and used for accounting and tax purposes.

The term “accounting journal information” refers to data representing one or more journal entries, each including at least a date, debit classification, credit classification, and amount.

The term “correction history information” refers to data indicating modifications made to accounting journal information, including content of changes, timestamps, and related identifiers.

The term “information management device” refers to a storage system or database system, implemented by hardware and software, that maintains, retrieves, and manages accounting data and related information.

The term “declaration data” refers to data formatted and structured in accordance with a taxation procedure format for use in preparing or submitting tax returns or other tax-related filings.

The term “transaction control” refers to a mechanism in a data management system that ensures atomicity, consistency, isolation, and durability of a set of data operations.

The term “identification information” refers to data used to uniquely identify and associate related elements, such as accounting data, image information, and prompt sentences, within the system.

The term “inquiry processing” refers to processing in which the system retrieves and provides information in response to a user's request, including searches or references to accounting data and associated information.

The term “correction processing” refers to processing in which the system modifies existing accounting data or related information based on instructions or conditions.

The term “interactive input/output unit” refers to a user interface implemented by hardware and software, such as a graphical user interface or messaging interface, that allows a user to input natural language instructions and receive responses.

The term “instruction information” refers to content expressed by a user, typically in natural language, that specifies operations such as search, correction, or generation to be performed on accounting data.

The term “natural language processing technique” refers to a computational method for analyzing and interpreting human language text, including parsing, intent detection, and entity extraction.

The term “control information” refers to data derived from instruction information that specifies search conditions, correction conditions, or other operational parameters used by the system to process accounting data.

The term “explanation information” refers to data provided to a generative information processing model that includes context, structured data, or descriptions used to guide the model's processing.

The term “automatic searching” refers to processing in which the system, without further manual specification of queries, retrieves accounting data according to conditions derived from instruction information and control information.

The term “automatic correction” refers to processing in which the system, without manual editing of individual records, modifies accounting data according to correction conditions derived from instruction information and control information.

The term “external knowledge processing device” refers to a system or service external to the server that provides expert or domain-specific processing, such as rule-based reasoning or advisory computation, based on provided data.

The term “cooperation processing” refers to processing in which a generative information processing model and an external knowledge processing device interact or exchange data to jointly generate result information.

The term “advice information” refers to data that provides guidance, recommendations, or evaluations related to accounting data or declaration data, generated by cooperation between the generative information processing model and an external knowledge processing device.

In one embodiment, a server, a terminal, and a user cooperate to implement the claimed system. The server includes at least one hardware processor, a main memory, a non-volatile storage device, and a network interface. The server operates under control of an operating system such as a generic server operating system and executes application software including an image processing module, an optical character recognition (OCR) module, a prompt generation module, a generative AI interface module, a rule-based accounting engine, and a data management module. The terminal includes a processor, a memory, a camera device, a display, and a communication module, and executes a communication application such as a generic messaging application or chat client. The user operates the terminal to capture image information of information recording media and to input instructions in natural language.

The server uses a hardware storage device such as a solid-state drive and a network interface conforming to standard communication protocols to receive image information from the terminal. The terminal uses the camera device to capture an image of an information recording medium, such as a receipt or an invoice, and the communication module to transmit the digital image file to the server. The server writes the received image information to the non-volatile storage device and registers a processing task in a job queue implemented by a message management component such as a generic queueing system. By implementing this reception and queuing at the server, the system stabilizes throughput, avoids memory overflow, and improves reliability of ingestion of large volumes of voucher images.

The server uses an image processing library such as a general-purpose computer vision library executing on the server processor to perform image processing techniques on the stored image information. The server converts the received compressed image file into an internal pixel array stored in main memory. The server applies noise removal by convolving the pixel array with a smoothing kernel, thereby suppressing high-frequency noise. The server performs resolution adjustment by resampling the image to a target resolution at which characters typically occupy a predetermined pixel height range. The server performs density correction by adjusting brightness and contrast via histogram equalization or gamma correction functions, so that characters have a higher intensity difference against the background. The server executes binarization by determining a threshold for each pixel (for example using an adaptive threshold algorithm) and assigning each pixel to a foreground or background label. The server further performs geometric correction by estimating a skew angle, for example using projection profiles, and rotating the image to align text lines horizontally, and by applying a perspective transformation based on detected document corners or edges.

The server, by structuring these operations as a specific ordered pipeline and tuning parameters such as kernel size, target resolution, threshold window size, and rotation angle, reduces the variance in appearance of voucher images that are captured under diverse conditions. This reduction in variance improves downstream character recognition accuracy, reduces the number of OCR errors that must be corrected, and thus increases overall processing speed and stability on the server hardware. The improvement is technical, because the server changes internal representations of pixel data and reduces the computational cost required for repeated recognition and manual correction.

The server uses a character recognition technique such as an OCR engine implemented in software executing on the processor to convert the preprocessed image information into character information. The server loads a character recognition model that may be based on convolutional neural networks and recurrent neural networks, or transformer-based encoders, trained on character images of multiple languages. The server supplies the binarized, geometrically corrected pixel array to the OCR engine. The OCR engine, for example in a neural network implementation, computes convolutional feature maps, applies non-linear activation functions such as rectified linear units, performs pooling operations, and propagates feature vectors through subsequent layers. The OCR engine outputs probability distributions over character classes at each position, and the server applies a decoding algorithm such as connectionist temporal classification (CTC) decoding to obtain a sequence of characters.

The server stores the resulting strings as character information in main memory and in a temporary data storage area. The server uses verification processing to improve the reliability of this character information. The server performs format determination by matching substrings against regular expression patterns for dates, currency amounts, and identifiers.

The server performs numerical value determination by parsing substrings as numeric types and discarding or flagging values that exceed expected ranges. The server performs date determination by mapping parsed year, month, and day values into calendar dates and rejecting impossible combinations. The server performs misrecognition correction by applying substitution rules and a dictionary of common words. For example, the server replaces ambiguous characters when context suggests that the character should be a digit instead of a letter.

The server, by performing these verification operations, transforms unstructured and potentially erroneous OCR output into a more consistent form. The server thereby reduces error propagation into subsequent accounting processing and reduces the amount of human intervention. The verification algorithms act as an additional layer of defense within the computer system, allowing the server to automatically discard or correct obviously erroneous patterns before any accounting rule is applied.

The server uses the verified character information to generate structured information. The server applies parsing logic that maps certain regions of the string or certain labeled tokens to fields such as transaction date, transaction amount, transaction counterpart, transaction content, and tax category. The server can use positional information (for example, approximate coordinates of text blocks in the image) and linguistic cues (for example, presence of currency symbols, tax labels, or vendor suffixes) as features. The server builds a structured record for each voucher, in which keys represent semantic fields and values represent extracted text or numeric values. The structured record is stored in a data structure such as a key-value map or an object in memory, and later in a relational database table with columns representing each field.

The server also uses accounting rule information stored in a data repository. The accounting rule information defines mappings from combinations of transaction content keywords, counterpart categories, and tax categories to internal account classifications. The server can implement this rule information as a table whose entries consist of feature patterns and output account codes, or as a parameter set in a rule engine. The server can compute feature vectors from the structured information by encoding fields using methods such as one-hot encoding for categories and normalization for numeric values. These feature vectors are used as part of subsequent processing by a generative AI model.

The server uses a prompt generation module to construct prompt sentences for a generative AI model. The server stores templates in which placeholders are defined for structured information fields and rule-related annotations. The server then fills in the placeholders with the extracted transaction date, transaction amount, transaction counterpart, and transaction content. For example, the server can generate a prompt sentence as follows:

“The following text was extracted from a receipt. Please identify the transaction date, total amount, tax amount if present, vendor name, and item description. Then select an appropriate accounting account title for each item based on small-business accounting rules and output a structured journal entry. OCR text: ‘Oct. 1, 2023 Stationery Store Stationery 500 yen’.” The server, by using such prompt sentences, encodes internal structured data into unambiguous instructions to the generative AI model. The prompt generation module may add explicit instructions about the desired output format, for example specifying that the generative AI model should output keys such as date, amount, vendor, description, account title, debit account, and credit account. The server stores the generated prompt sentences in association with the corresponding voucher records, thereby allowing reproducibility and auditability of the generative AI interactions.

The server uses a generative AI interface module to communicate with a generative information processing model. The server may host the generative AI model locally or access it via an external service. In one embodiment, the generative AI model is implemented as a transformer-based language model with multiple encoder-decoder layers. The model represents tokens of the prompt sentence and additional context, such as embedded structured information, as high-dimensional vectors, and applies self-attention mechanisms to compute contextualized representations. The model is trained in advance using supervised learning on data that pairs textual descriptions of transactions with correct accounting classifications. During training, the server or a training environment provides prompt sentences as input and desired structured outputs as targets. The training process minimizes a loss function such as cross-entropy between predicted tokens and target tokens. The server or training environment updates the model weights using an optimization algorithm such as stochastic gradient descent or Adam, with backpropagation of gradients through the transformer layers. The server, during inference, sets parameters such as temperature and maximum output length for the generative AI model, and supplies the prompt sentence via an API. The server receives a sequence of output tokens, converts them back into text, and parses the output into internal structured data. The generative AI interface module checks that required fields are present and that the output conforms to expected formats. The server uses error handling routines to detect incomplete or malformed outputs and may, in such cases, construct an additional prompt sentence requesting clarification or re-generation.

The server also uses a rule-based accounting engine in combination with the generative AI output. The server maps the account titles suggested by the generative AI model to internal account codes defined in an account master table. The server checks whether the suggested account title exists; if not, the server can apply fallback rules, such as mapping to a generic miscellaneous expense account based on a similarity metric computed over account names. The server also computes debit and credit entries according to standardized double-entry accounting rules stored in a configuration table. The server thereby ensures that the journal entries generated are not only contextually appropriate but also structurally consistent in terms of accounting logic.

The server creates accounting journal information that includes transaction date, debit classification, credit classification, account classification, and amount. The server also initializes correction history information for each journal entry. The server then uses a data management module to store the accounting data in an information management device such as a relational database management system. The server establishes a database connection through a driver and initiates a transaction. The server inserts records into tables representing vouchers, journal entries, and associations between vouchers and prompts. If all inserts succeed, the server commits the transaction; otherwise, the server rolls back the changes. The use of transaction control guarantees atomicity and consistency of accounting data, thereby preventing partial updates that could cause inconsistencies between stored images, prompts, and journal entries.

The server, after storing the accounting data, generates declaration data. The server executes aggregation queries on the accounting tables to compute totals for each tax category over specified periods. The server formats the aggregated data into a data structure complying with tax filing formats, such as a table of taxable sales, non-taxable sales, and deductible expenses. The server can output declaration data as a structured file format or as records ready for electronic submission. By implementing this conversion within the server, the system reduces manual re-entry of accounting data into tax form software and provides a technically integrated path from image capture to tax declaration.

The server, in addition, records identification information that associates the original image information, the prompt sentence, and the resulting accounting data. The server stores an identifier in each of the voucher, prompt log, and journal tables so that later retrieval of all related items is possible with a single key. When an inquiry or correction is requested, the server can quickly retrieve the entire history of processing for a given voucher. This linkage improves traceability and supports technical debugging and auditing of the generative AI behavior.

The user interacts with the system by issuing natural language instructions through the terminal. The terminal provides a text input field and sends the user's instruction information to the server via the communication application. For example, the user may enter: “Show me all stationery expenses for October 2023.” The server receives this instruction and uses a natural language processing module to analyze the text. The server uses tokenization, part-of-speech tagging, and semantic parsing algorithms to identify intent and entities in the instruction. The server converts the natural language instruction into control information that specifies a search condition, for example: account classification equal to supplies expense and transaction date between Oct. 1, 2023 and Oct. 31, 2023.

The server then creates a new prompt sentence for the generative AI model to assist with more complex or ambiguous queries. For example, the server may generate:

“You are an assistant that translates user requests into filters for accounting data. The user said: ‘Show me all stationery expenses for October 2023.’ The accounting data has fields: date, account title, amount, vendor. Please output filter conditions for selecting entries related to stationery in October 2023.”

The server sends this prompt sentence together with partial schema information to the generative AI model. The generative AI model outputs filter descriptions, such as “date from 2023 Oct. 1 to 2023 Oct. 31 and account title including ‘supplies expense’.” The server validates the output and translates it into an executable query for the database. The server retrieves the matching accounting data and formats it into a text summary that the terminal can display. The user thus receives a list of dates, vendors, and amounts corresponding to stationery expenses.

The user can also request corrections in natural language. The user may send: “Change the account for the October 1 stationery receipt to office supplies.” The server parses this text and identifies that this is a correction operation. The server retrieves candidate journal entries for October 1 that involve stationery-related descriptions and constructs a prompt for the generative AI model:

“The user said: ‘Change the account for the October 1 stationery receipt to office supplies.’

The following are existing journal entries. Identify the entry that matches this description and specify the new account title ‘office supplies’ for that entry.”

The server sends this prompt along with serialized representations of the candidate entries. The generative AI model returns an identification of the target entry and the updated account title. The server checks that the new account title is present in the account master table, and then performs an update in the database inside a transaction. The server records the correction history information, noting the previous value, the new value, and the time of the change. The server sends a confirmation message back to the terminal for display to the user.

The described configuration provides technical effects beyond mere automation of human accounting work. The server, by implementing an integrated pipeline of image preprocessing, OCR verification, structured information generation, prompt-based generative AI interaction, and transaction-controlled storage, reduces recognition errors and the need for manual data fixing. The server improves processing speed by minimizing repeated OCR runs and by using validated intermediate representations. The server improves data management by enforcing consistency and traceability at every stage, so that every journal entry can be traced back to its origin. The server improves computational efficiency by applying image preprocessing tuned for OCR and by using structured prompts and output formats that minimize ambiguous interpretation by the generative AI model.

Moreover, the server implements AI processing in a way that differs from conventional human-centric workflows. The generative AI model uses internal learned parameters obtained from large-scale training to infer complex relationships between textual descriptions and accounting classifications, which would be difficult to encode manually as fixed rules. The server applies non-traditional steps, such as encoding context into prompt sentences, logging prompts and responses for reproducibility, and combining the generative output with rule-based checks. These measures result in a computer system that can adapt to new voucher formats, scale to high volumes of data, and maintain high accuracy without proportional increases in human labor. The combination of deterministic preprocessing and verification with probabilistic generative modeling constitutes a technical architecture that improves how the computer processes and stores accounting-related information.

In alternative embodiments, the server may use different neural network architectures for OCR and for the generative AI model, such as bidirectional recurrent networks or convolutional sequence models. The server may adjust hyperparameters such as the number of layers, the number of attention heads, the learning rate schedule, and the size of hidden representations to balance accuracy and computational cost. The server may also apply data augmentation techniques, such as random rotations and brightness changes, during model training to improve robustness to real-world imaging conditions. The server may implement different database structures, such as columnar storage or sharded architectures, to scale the information management device. The server may further integrate additional modules, such as anomaly detection engines that flag unusual transactions using statistical models, all within the same framework of structured information and prompt-based generative processing.

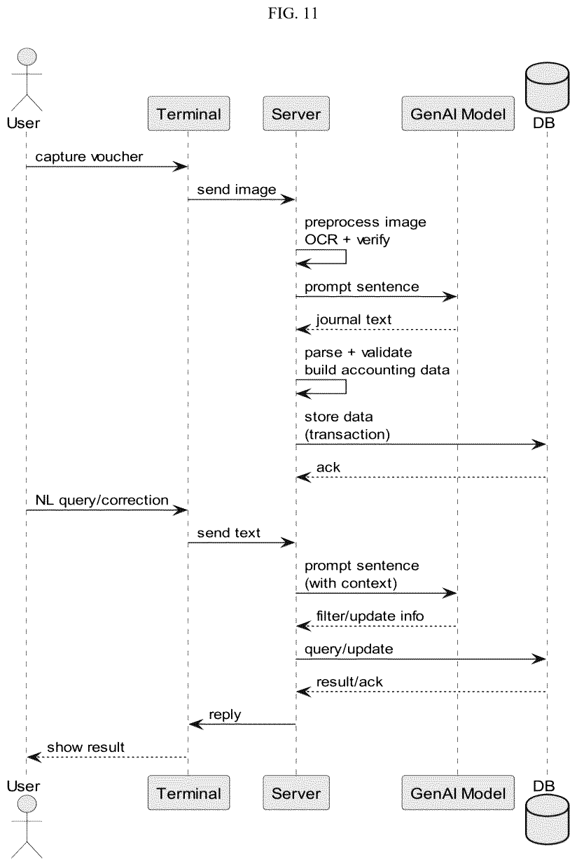

The following describes the processing flow using FIG. 11.

### Step 1:

The user activates a communication application on the terminal and selects a function for registering a transaction voucher.

The terminal uses an imaging device to capture an image of an information recording medium such as a receipt or invoice.

The terminal compresses the captured image into a digital file and attaches metadata such as a user identifier and a capture timestamp.

The terminal transmits the image file and the metadata to the server via a network connection using a communication protocol.

Input: the physical information recording medium and user operation on the terminal.

Output: a digital image file and associated metadata transmitted from the terminal to the server.

### Step 2:

The server receives the network request containing the digital image file and metadata from the terminal.

The server writes the received image file to a non-volatile storage device and registers a new processing job into a job queue managed in memory or a message system.

The server generates an internal voucher identifier and associates the image storage path and metadata with this identifier in a preliminary record.

Input: the digital image file and metadata received over the network.

Output: a stored image file, a registered job entry, and an internal voucher identifier recorded in a preliminary data structure.

### Step 3:

The server retrieves a pending job from the job queue and loads the corresponding image file from the storage device into main memory as a pixel array.

The server applies noise removal by convolving the pixel array with a smoothing kernel to attenuate random high-frequency variations.

The server adjusts the resolution by resampling the pixel array to a predetermined width and height suitable for subsequent processing.

The server performs density correction by modifying pixel intensity values, using algorithms such as histogram equalization, to increase the contrast between foreground characters and background.

The server performs binarization by computing threshold values for each region or pixel and assigning each pixel to a foreground or background class.

The server performs geometric correction by estimating skew or perspective distortion and applying a rotation and perspective transform to align text lines horizontally.

Input: the stored digital image file corresponding to the voucher identifier.

Output: a preprocessed pixel array representing a noise-reduced, contrast-enhanced, binarized, and geometrically corrected image stored in memory.

### Step 4:

The server supplies the preprocessed pixel array to an OCR module that executes a trained character recognition model.

The server causes the OCR module to compute feature maps, perform classification of character segments, and decode a sequence of characters from the image.

The server collects the output as raw character strings, optionally with positional data, and stores them as character information in memory.

Input: the preprocessed pixel array from Step 3.

Output: raw character information including one or more strings representing content of the information recording medium.

### Step 5:

The server performs verification processing on the raw character information.

The server applies format determination by matching substrings to patterns representing dates, currency amounts, and identifiers using regular expressions.

The server executes numerical value determination by parsing candidate substrings as numeric values and discarding or flagging values outside expected ranges.

The server performs date determination by splitting candidate date strings into year, month, and day components and verifying that each combination corresponds to a valid calendar date.

The server applies misrecognition correction by replacing characters that likely result from OCR errors using predefined substitution rules and lexical dictionaries.

Input: the raw character information produced in Step 4.

Output: verified and corrected character information with candidate dates, amounts, counterpart names, and descriptions labeled.

### Step 6:

The server generates structured information based on the verified character information.

The server identifies segments corresponding to a transaction date, a transaction amount, a transaction counterpart, transaction content, and a tax category by using positional cues, keyword detection, and pattern recognition.

The server encapsulates these segments into a structured record, such as a set of labeled fields or a row for a relational table, and associates the record with the voucher identifier.

Input: the verified character information from Step 5.

Output: structured information including labeled fields for date, amount, counterpart, content, and tax category.

### Step 7:

The server consults stored accounting rule information that maps combinations of content keywords, counterpart attributes, and tax categories to account classifications, debit classifications, and credit classifications.

The server computes feature representations for the structured information, for example by encoding categorical values and normalizing numerical values, and optionally applies rule checking to derive preliminary account candidates.

The server combines the structured information and any preliminary account candidates to form context data for generative processing.

Input: the structured information from Step 6 and the accounting rule information stored on the server.

Output: context data indicating the structured information and any initial mapping candidates for subsequent generative AI processing.

### Step 8:

The server uses a prompt generation module to create a prompt sentence for a generative AI model.

The server inserts elements of the structured information and context data into a natural-language template that describes the task to be performed.

The server includes instructions for the generative AI model to select appropriate account classifications, debit classifications, credit classifications, and amounts, and to generate accounting journal information.

The server forms a prompt sentence such as: “The following text was extracted from a receipt. Please identify the transaction date, total amount, tax amount if present, vendor name, and item description. Then select an appropriate accounting account title for each item based on accounting rules and output a structured journal entry. OCR text: ‘Oct. 1, 2023 Stationery Store Stationery 500 yen’.”

The server stores the generated prompt sentence in association with the voucher identifier.

Input: the context data containing structured information and accounting rule context.

Output: a prompt sentence prepared for submission to the generative AI model and logged with its associated identifier.

### Step 9:

The server sends the prompt sentence and, as needed, supplementary structured information to the generative AI model via an interface module.

The server sets inference parameters such as output length and sampling control and transmits the prompt sentence through a communication interface or local API call.

The server receives output text from the generative AI model, which describes accounting classifications, debit and credit sides, and amounts in response to the prompt sentence.

The server parses the output text to extract accounting journal information, including fields such as date, account classification, debit classification, credit classification, and monetary amount.

Input: the prompt sentence and associated structured information from Step 8.

Output: parsed accounting journal information generated by the generative AI model in response to the prompt sentence.

### Step 10:

The server verifies the accounting journal information against internal accounting rule information and account master data.

The server checks that each account classification exists in an account table and that debits and credits are balanced for each journal entry.

The server applies rule-based corrections or fallbacks when the suggested account classification is not recognized, for example mapping to a predefined generic account.

The server generates correction history information indicating transformations applied to the accounting journal information, including previous values, new values, and reasons for change.

Input: the accounting journal information generated in Step 9 and the stored accounting rule information and account master data.

Output: validated accounting journal information and corresponding correction history information.

### Step 11:

The server constructs accounting data records that link the voucher identifier, the structured information, the validated accounting journal information, and the correction history information.

The server initiates a transaction with an information management device such as a database system and inserts the accounting data into related tables for vouchers, journal entries, and histories.

The server commits the transaction if all insert operations succeed or rolls back the transaction in case of errors, preserving atomicity and consistency.

Input: the validated accounting journal information, correction history information, and voucher identifier from previous steps.

Output: persistent accounting data stored in the information management device with transaction-controlled consistency.

### Step 12:

The server generates declaration data by aggregating accounting data according to tax periods and tax categories.

The server executes aggregation operations, such as summations and groupings, over the stored accounting data to produce totals for different categories needed for taxation procedures.

The server formats the aggregated results into a data structure compatible with a taxation procedure format, for example specifying taxed amounts, non-taxed amounts, and deductible expenses.

Input: the persistent accounting data stored in the information management device.

Output: declaration data corresponding to required taxation formats for further use or submission.

### Step 13:

The user issues a natural-language inquiry or correction instruction through the terminal, such as “Show me all stationery expenses for October 2023” or “Change the account for the October 1 stationery receipt to office supplies.”

The terminal transmits the text of the instruction to the server via the communication application.

The server performs natural language processing on the instruction to identify the operation type (inquiry or correction) and to extract entities such as dates, account descriptions, and amounts.

The server transforms the extracted intent and entities into control information that specifies search conditions or correction conditions for the accounting data.

Input: the natural-language instruction provided by the user through the terminal.

Output: control information expressing search or correction conditions derived from the user's natural-language instruction.

### Step 14:

The server generates a new prompt sentence for the generative AI model to refine or disambiguate the control information and to guide complex search or correction logic.

The server embeds the natural-language instruction, the preliminary control information, and, when necessary, sample accounting data or schema descriptions into a prompt template.

The server forms a prompt sentence such as: “You are an assistant that translates user requests into filters for accounting data. The user said: ‘Show me all stationery expenses for October 2023.’ The accounting data has fields: date, account title, amount, vendor. Please output filter conditions for selecting entries related to stationery in October 2023.”

The server sends the prompt sentence to the generative AI model and receives output describing specific filter conditions or update targets and values.

The server converts the model output into executable queries or update commands for the database.

Input: the control information and any relevant accounting data context.

Output: refined search or correction conditions and corresponding database operations derived via the prompt sentence.

### Step 15:

The server executes the search or correction operations on the information management device according to the refined conditions produced in Step 14.

The server, for a search, retrieves accounting data records matching the specified filters and formats the results into a human-readable summary.

The server, for a correction, updates target accounting data fields and appends new entries to correction history records within a database transaction.

The server sends the search results or confirmation of completed corrections to the terminal for display to the user.

Input: the refined database operations and conditions obtained via the generative AI process.

Output: updated accounting data in the database when corrections are requested and formatted response messages delivered to the terminal for user confirmation or review.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented expense management and tax preparation systems generally rely on a pipeline in which receipt images are processed by fixed-function optical character recognition (OCR) engines and rule-based parsers, and then mapped into accounting data formats by predetermined business logic. In such systems, each processing stage is narrowly tailored to a specific document layout or use case, and changes in receipt formats, tax regulations, or user requirements typically require manual redesign and redeployment of program logic. This results in a rigid architecture that is difficult to adapt and scale.

Furthermore, in many existing systems, the user interface for correcting or confirming accounting data is decoupled from the underlying data processing pipeline. Users are forced to interact with complex, form-based graphical user interfaces, while the back-end system cannot flexibly interpret natural language instructions or context. As a result, even minor corrections or review operations require multiple manual steps, increase the risk of inconsistency between front-end and back-end processing, and prevent automation of higher-level tasks such as bulk corrections, data summarization, or tax allocation.

In addition, although large-scale generative artificial intelligence models have emerged as powerful tools for interpreting unstructured text, images, and instructions, conventional accounting and tax systems do not effectively integrate such models into the core data processing path. Typical integrations, if present, treat the generative model as an advisory layer, separate from the primary data pipeline, and do not provide a structured and verifiable interface. Consequently, outputs from the generative model cannot be reliably used as machine-readable instructions for updating accounting data, and concerns remain regarding traceability, determinism, and safety in the context of financial records.

Moreover, existing OCR and classification pipelines typically operate as one-way transformations: they convert images into text and then into accounting records, but they do not establish a coherent, programmable interface for iterative refinement. When OCR errors or classification inaccuracies occur, there is no standardized mechanism for a user to issue high-level natural language commands that are automatically translated into precise, machine-executable update operations. This lack of a closed-loop mechanism between user input, generative models, and structured data updates leads to inefficient workflows and limits the overall reliability and usability of the system.

From the perspective of computer technology, there is therefore a need for an improved architecture that tightly integrates image preprocessing, OCR, structured data generation, and generative artificial intelligence models through explicit prompt sentences and machine-readable command formats. Such an architecture should allow a processor to: (i) convert unstructured image and text inputs into normalized, structured accounting and tax data, (ii) construct context-rich prompts that constrain and guide the generative model, (iii) interpret the model's outputs as deterministic update instructions for data structures, and (iv) maintain end-to-end traceability between raw inputs, prompts, model outputs, and final stored accounting data. This constitutes an improvement in computer technology itself, as it enhances how computing systems process heterogeneous data sources, how they orchestrate collaboration between deterministic modules and generative models, and how they expose robust, natural-language-based control surfaces to users without sacrificing structure, safety, or auditability.

The specific processing by the specific processing unit 290 of the data processing device 12 in Application Example 1 is realized by the following means.

The present invention provides a server comprising a processor and a memory storing instructions that, when executed by the processor, cause the processor to receive, via a communication application, image data representing transaction evidence information transmitted from a terminal having a communication function; perform preprocessing on the image data using an image processing technique including at least one of resolution correction, noise reduction, contrast correction, binarization, distortion correction, and region extraction; extract text information from the preprocessed image data by using a character recognition technique; generate structured data including at least a transaction date, an amount, a transaction entity, and a transaction type on the basis of the text information and perform a classification process for estimating an expense category on the basis of the structured data; generate a prompt sentence including the structured data and a result of the classification process and describing content for causing a generative artificial intelligence model to execute accounting processing or tax processing, and input the prompt sentence to the generative artificial intelligence model; generate accounting data including journal information, expense category information, and tax return information on the basis of a response output from the generative artificial intelligence model; convert the accounting data into a data format compatible with an external accounting processing information service, transmit the accounting data to the external accounting processing information service via a communication interface, and store the accounting data in a storage device for recording; convert the accounting data stored in the storage device for recording into a data structure corresponding to a format of a tax return form and output the converted data as tax return data; and receive, via the communication application, a natural language inquiry or correction request transmitted from the terminal or a user, generate an additional prompt sentence including the natural language data and the accounting data and describing content for causing the generative artificial intelligence model to instruct correction, deletion, aggregation, or confirmation of the accounting data, input the additional prompt sentence to the generative artificial intelligence model, obtain from the generative artificial intelligence model instruction information in a machine-readable format specifying an update target and update content of the accounting data, update the accounting data on the basis of the instruction information, and notify a result of the update to the terminal via the communication application. This enables a computer system to implement an integrated, closed-loop processing architecture in which image-based transaction evidence, structured accounting and tax data, and natural-language interactions are coherently managed through explicit prompt sentences and machine-readable commands, thereby improving the technical functioning of the system in terms of data normalization, adaptability to varying document formats, automated error correction, reliability, and traceable interaction between deterministic processing components and a generative artificial intelligence model.

The term “system” refers to a combination of one or more hardware units and one or more software components that cooperate to execute the functions described in the claims, including at least a processor, a memory, and communication interfaces.

The term “processor” refers to one or more hardware processing units, such as a central processing unit or a graphics processing unit, capable of executing instructions to perform arithmetic, logical, control, and input/output operations.

The term “memory” refers to one or more non-transitory computer-readable storage media, such as semiconductor memory, magnetic storage, or optical storage, configured to store instructions and data used by the processor.

The term “terminal” refers to an information processing apparatus having at least a user interface, a communication function, and an imaging device, such as a mobile communication device, a tablet device, or a portable computing device, which transmits and receives data with the server.

The term “communication application” refers to a computer program executed on the terminal or the server that enables transmission and reception of messages and data, including text and images, between endpoints over a communication network.

The term “transaction evidence information” refers to information indicating details of a commercial or financial transaction, including at least one of a receipt, an invoice, a statement, or a similar document that evidences a transaction.

The term “image data” refers to digital data representing a still image or a sequence of images, including data formats such as bitmap data or compressed image data, that depict transaction evidence information.

The term “imaging device” refers to hardware for capturing an image, such as a digital camera or an image sensor, integrated into or connected to the terminal.

The term “settlement event” refers to an event indicating completion of a payment process for a transaction, including but not limited to authorization, approval, or confirmation of a financial charge.

The term “image processing technique” refers to one or more computational operations applied to image data to modify, enhance, or analyze the image data, including operations such as resolution adjustment, noise reduction, and geometric correction.

The term “resolution correction” refers to processing that adjusts the spatial resolution of image data, including scaling, resampling, or interpolation, to obtain an image suitable for further analysis.

The term “noise reduction” refers to processing that suppresses random or unwanted variations in pixel values of image data in order to improve clarity of the image.

The term “contrast correction” refers to processing that adjusts the dynamic range or distribution of pixel intensities in image data to increase the distinguishability of foreground and background regions or features.

The term “binarization” refers to processing that converts grayscale or color image data into image data having two intensity levels, such as black and white, based on one or more threshold values.

The term “distortion correction” refers to processing that compensates for geometric distortions in image data, including skew, perspective distortion, and lens distortion, to approximate the original shape of the imaged object.

The term “region extraction” refers to processing that identifies and isolates one or more areas of interest within image data, such as a region containing text or a specific portion of a document, from surrounding image content.

The term “character recognition technique” refers to a computational method, including optical character recognition, that analyzes image data to identify and convert visual representations of characters or symbols into corresponding digital text information.

The term “text information” refers to alphanumeric characters, symbols, and strings obtained by applying a character recognition technique to image data, including lines of text and structured textual content.

The term “structured data” refers to data organized into one or more predefined fields or attributes, such as a transaction date, an amount, a transaction entity, and a transaction type, in a format suitable for programmatic manipulation and storage.

The term “transaction date” refers to data indicating a point in time or a calendar date on which a transaction occurred or was recorded.

The term “amount” refers to numeric data indicating a monetary value associated with a transaction, optionally including a currency unit.

The term “transaction entity” refers to data identifying a party related to a transaction, such as a payee, a payer, a vendor, or a service provider.

The term “transaction type” refers to data indicating a classification of a transaction according to its nature, such as purchase, sale, refund, fee, or similar categories.

The term “classification process” refers to computational processing that assigns one or more categories or labels to structured data on the basis of features extracted from the data and a predetermined model or rule set.

The term “expense category” refers to a label representing a type of cost, such as travel, meals, office supplies, or utilities, used for accounting or tax purposes.

The term “generative artificial intelligence model” refers to a machine learning model, such as a neural network-based language model, configured to generate output data, including natural language text or structured data, in response to input data, including prompt sentences and context.

The term “prompt sentence” refers to machine-readable input data, including natural language text and optionally structured context information, supplied to a generative artificial intelligence model to instruct the model to produce a particular type of output.

The term “accounting processing” refers to computational operations that generate or update accounting records, including operations such as journal entry creation, categorization of expenses, allocation of amounts to accounts, and aggregation of financial data.

The term “tax processing” refers to computational operations that derive or update tax-related data based on accounting data, including operations such as calculation of taxable income, determination of deductible expenses, and preparation of tax-relevant summaries.

The term “accounting data” refers to structured information representing financial transactions, including at least journal information, expense category information, and tax-related attributes, stored for use in accounting systems.

The term “journal information” refers to data representing entries in an accounting ledger, including at least dates, account identifiers, debit amounts, credit amounts, and narratives or descriptions of transactions.

The term “tax return information” refers to data necessary for preparation or filing of a tax return, including income amounts, deductible amounts, tax bases, and other tax-relevant figures derived from accounting data.

The term “external accounting processing information service” refers to a remote or separate information processing system, accessible via a communication network, that performs one or more accounting-related functions, such as bookkeeping, financial reporting, or tax preparation.

The term “communication interface” refers to hardware and software that enable data exchange between the system and an external device or service over a communication network, using one or more communication protocols.

The term “storage device for recording” refers to a non-transitory computer-readable storage medium or a combination of such media configured to persistently store accounting data, tax data, and related information.

The term “data format compatible with an external accounting processing information service” refers to a representation of data organized in accordance with a specification, schema, or protocol accepted by an external accounting processing information service for import or processing.

The term “data structure corresponding to a format of a tax return form” refers to a structured representation of data whose fields and relationships align with the items or lines specified by a tax return form used by a tax authority.

The term “tax return data” refers to structured data formatted according to a tax authority's return form requirements and including values that can be used directly or indirectly for filing a tax return.

The term “natural language inquiry” refers to a request or question expressed in a human language, such as an everyday written sentence, that is sent by a user or a terminal to the system via the communication application.

The term “correction request” refers to a natural language instruction or command that instructs a change to existing accounting data, including but not limited to modification, deletion, or reclassification of transaction records.

The term “additional prompt sentence” refers to a prompt sentence generated after initial accounting data generation, the additional prompt sentence including current accounting data and new natural language input so as to cause a generative artificial intelligence model to perform a subsequent operation, such as data correction or verification.

The term “machine-readable format” refers to a representation of data, such as a structured text format or a data structure, that can be parsed and processed by a computer program without human interpretation, for example a key-value structure or a list of command objects.

The term “instruction information” refers to data specifying one or more operations to be applied to accounting data, including identification of an update target, the type of operation, and parameters of the operation, in a format that is executable or interpretable by the system.

The term “update target” refers to a particular record, field, or set of fields within accounting data that is designated to be modified, deleted, or otherwise changed.

The term “update content” refers to the specific new value or transformation to be applied to an update target, including a new category, a corrected amount, a revised date, or other altered data.

The term “aggregation” refers to a process that combines multiple pieces of accounting data according to one or more criteria, such as time period, category, or entity, to compute summarized values or grouped data.

The term “confirmation” refers to a process that checks consistency, completeness, or correctness of accounting data, possibly in response to a natural language inquiry, and outputs a result indicating whether the data satisfies predefined conditions.

The term “expert judgment” refers to evaluation or decision-making that uses domain-specific rules, models, or heuristics related to accounting or tax matters, which may be implemented in an external information processing apparatus or encoded in a knowledge-based system.

The term “external information processing apparatus that performs expert judgment” refers to a separate computing system configured to execute expert algorithms or rule sets to generate advice or conclusions in specialized domains such as accounting or taxation.

The term “cooperation conditions” refers to parameters, constraints, or protocols that define how the system exchanges data and synchronizes operations with an external information processing apparatus that performs expert judgment.

The term “advice information” refers to output data that provides recommendations, suggestions, or guidance concerning accounting data or tax return data, based on analysis by a generative artificial intelligence model or an external expert system.

The term “confirmation result” refers to output data indicating an outcome of a verification or validation process applied to accounting data or tax return data, such as an indication of correctness, inconsistency, or required revision.

In one embodiment, a server implements the invention by executing computer programs stored in a non-transitory memory and executed by at least one processor. The server operates in conjunction with one or more terminals, a communication network, and an external accounting processing information service. The server uses commodity hardware, such as a multi-core central processing unit and an optional graphics processing unit, and runs a general-purpose operating system such as a UNIX-like operating system. The server additionally uses a database management system, an image processing library, a character recognition engine, a machine learning framework, and a generative AI model runtime, which cooperate to implement the claimed functions.

The terminal implements a communication application that allows a user to exchange text and image data with the server. The terminal includes an imaging device such as a camera sensor, a display, a touch input unit, and a network interface. The terminal uses a mobile operating system such as a smartphone operating system to control the imaging device and the communication application. The terminal uses a software development kit to access the camera hardware and to transmit captured image data to the server through the communication application.

The user operates the terminal to perform financial transactions in the real world, for example by paying at a point-of-sale terminal. The terminal, in response to detection of a settlement event generated by a payment application or a notification service, activates the imaging device and captures an image of a receipt or other transaction evidence information. The terminal compresses the image into a standard image format and attaches the image to a message in the communication application. The terminal then transmits the message to the server over a communication network, such as a cellular or wireless network, using encrypted transport protocols.

The server receives image data representing transaction evidence information through an interface that is integrated with an application programming interface of the communication application platform. The server stores the received image data in a persistent storage device, such as a disk array, and records metadata including a user identifier, a timestamp, and a communication session identifier in a relational database. The server then performs image preprocessing using an image processing library such as a general-purpose open-source library that provides functions for resolution correction, noise reduction, contrast correction, binarization, distortion correction, and region extraction.

The server uses the image processing library to apply a sequence of deterministic transformations to the image data. The server applies resolution correction by resampling the image to a target pixel density suitable for text recognition, for example by performing bilinear or bicubic interpolation. The server applies noise reduction by using filters such as median filters or Gaussian filters to remove small-scale intensity variations. The server performs contrast correction by performing histogram equalization or gamma correction to enhance the difference between text foreground and background. The server performs binarization by computing an adaptive threshold for local regions and converting pixel values above the threshold to a foreground value and pixel values below the threshold to a background value. The server performs distortion correction by detecting lines and corners using edge detection and Hough transform techniques, estimating skew angle and perspective parameters, and warping the image so that the text lines become approximately horizontal.

The server performs region extraction by segmenting the image into a main document region and background regions using connected component analysis or contour detection and cropping the main document region.

The server applies a character recognition technique such as an optical character recognition engine to the preprocessed image. The server configures the OCR engine with language models for relevant languages and a page segmentation mode suitable for receipts. The server invokes the OCR engine to analyze the preprocessed image and obtain text information. The server receives from the OCR engine a sequence of text lines, optionally accompanied by positional information such as bounding box coordinates. The server stores the raw OCR output in the database associated with the corresponding image record.

The server generates structured data by parsing the OCR text. The server uses regular expressions, tokenization, and custom parsing rules to identify patterns that correspond to a transaction date, an amount, a transaction entity, and a transaction type. The server converts date strings into a normalized date representation using a date parsing library. The server extracts monetary amounts by detecting numeric patterns near keywords such as “Total” or equivalent localized terms, and normalizes those values into numerical data fields. The server identifies a transaction entity by analyzing the top lines of the OCR result and filtering out generic words that indicate document type rather than a vendor or payee. The server determines a transaction type, such as purchase or refund, by scanning for indicative keywords or phrases in the OCR text. The server stores the structured data as records in the database, with predefined fields corresponding to date, amount, entity, type, and references to the original image and OCR text.

The server performs a classification process for estimating an expense category for each transaction. In one embodiment, the server uses a supervised machine learning model implemented in a machine learning framework such as a general deep learning library. The server uses a neural network model that receives as input a feature vector derived from the structured data and the OCR text. The server constructs the feature vector by including numerical features such as normalized amount and time-of-day, categorical features such as one-hot encodings of transaction type, and textual features derived from tokenizing the vendor name and selected OCR text lines and mapping tokens to embeddings. The server uses a neural network architecture that includes at least one embedding layer for textual tokens, one or more fully connected layers, and an output layer with a softmax activation function that produces a probability distribution over possible expense categories.

The server trains the classification model offline by using historical labeled transaction data.

The server optimizes model parameters by minimizing a loss function such as cross-entropy loss between predicted category probabilities and true category labels, using gradient-based optimization such as stochastic gradient descent with adaptive learning rate adjustments. The server uses regularization techniques such as dropout or weight decay and may apply data augmentation to simulate OCR noise or variations in vendor names. Once trained, the server deploys the model as part of the runtime system and uses it to compute the most likely expense category and an associated confidence score for each new transaction. The server stores the predicted category and the score as part of the structured data.

The server generates a prompt sentence for a generative AI model by incorporating the structured data and classification results into a natural language template. The server constructs the prompt sentence to explicitly instruct the generative AI model to perform accounting processing or tax processing in a constrained and machine-usable manner. The server includes in the prompt sentence a description of the transaction fields, the candidate expense category, and required output format. For example, the server may generate a prompt sentence such as:

“From the following transaction information, determine how it should be recorded in the accounting ledger.
Transaction date: 2023 Oct. 5
Amount: 500 JPY
Entity: STORE ABC
Type: purchase
Candidate expense category: Office Supplies

Describe the appropriate journal entry and confirm the expense category in plain text.”

The server transmits the prompt sentence to a generative AI model implemented as a large-scale neural network language model. In one embodiment, the generative AI model is a transformer-based architecture comprising multiple layers of self-attention and feedforward networks, trained on large corpora of text data. The generative AI model receives the prompt sentence as a sequence of token embeddings and internally computes attention weights and hidden representations across multiple layers to produce a sequence of output tokens. The generative AI model generates a response that contains a textual description of appropriate accounting treatment, such as debit and credit accounts, and confirmation or adjustment of the expense category. The server receives this response, parses it using pattern matching or simple natural language processing to extract key elements, and produces accounting data that includes journal information, expense category information, and tax return information.

The server converts the accounting data into a data format compatible with an external accounting processing information service. The server maps internal field names to the schema required by the external service, formats date strings and currency values as specified, and packages the data into a serialized format such as a structured text message.

The server transmits the data to the external service over a secure communication interface using an application programming interface. The server receives a confirmation or error message from the external service and stores the external reference identifier or error status in the database. The server thereby ensures that the accounting records in the local system are synchronized with records maintained by the external service.

The server converts accounting data stored in the storage device into a data structure corresponding to a format of a tax return form. The server maintains a mapping between internal accounting fields and fields defined by a tax authority's return form, including line numbers, section identifiers, and categories such as income, deductible expenses, and tax credits. The server aggregates relevant transactions per category and period, computes intermediate totals and tax-relevant values, and populates a structured representation of the tax return. The server outputs the resulting tax return data in a form suitable for further processing, such as a file format accepted by an electronic filing system or a human-readable representation for review.

The user interacts with the system by sending natural language inquiries or correction requests through the communication application on the terminal. The user may, for example, transmit a message such as “Change the category of today's 500 yen purchase at STORE ABC to Travel” or “Summarize my transportation expenses for October 2023.” The terminal transmits these messages to the server as text data.

The server receives the natural language inquiry or correction request and generates an additional prompt sentence for the generative AI model. The server first queries the database to retrieve relevant accounting data associated with the user, such as all transactions matching the date, amount, and entity mentioned in the user's message. The server formats these transactions as textual descriptions and inserts them into the additional prompt sentence along with the user's instruction and explicit constraints regarding allowed operations and desired output format. For example, the server may generate an additional prompt sentence such as: “You are a tool that manages expense records.

User instruction: ‘Please change today's 500 yen receipt at STORE ABC to category Travel.’ Current transactions:
1) ID: tx_001, date: 2023 Oct. 5, entity: STORE ABC, amount: 500 JPY, category: Office Supplies

Describe which transaction should be updated and which new category should be applied.”

The server sends this additional prompt sentence to the generative AI model and receives a response that describes, in natural language, which transaction should be changed and what the new category should be. The server parses the response to obtain instruction information in a machine-readable form, such as an identified transaction identifier and a specified new category. The server updates the corresponding record in the database by changing the category field while maintaining a history of the change. The server updates synchronized records on the external accounting service as needed and transmits a confirmation message to the terminal via the communication application, informing the user of the completed change.

The server uses this architecture to achieve technical effects that go beyond mere automation of human tasks. By integrating image preprocessing, OCR, structured data extraction, classification, and generative AI-driven prompting into a closed-loop pipeline, the server reduces error rates associated with OCR on low-quality images, improves the speed and accuracy of category assignment, and provides a robust mechanism for iterative correction of records through natural language instructions. The use of explicit prompt sentences and constrained output expectations enables the generative AI model to be used as a component in a deterministic processing pipeline rather than as an uncontrolled text generator. The server maintains traceability between the original image, the intermediate structured data, the prompt sentences, the generative AI model outputs, and the final accounting records, which improves data management and auditability.

The server improves computer technology by optimizing how heterogeneous data streams are processed. The image preprocessing pipeline, by normalizing varied receipt images into standardized inputs for OCR, reduces computational load and increases recognition accuracy, resulting in fewer reprocessing cycles and lower network usage. The classification model, by using neural network-based feature extraction rather than simple rule-based heuristics, adapts to new vendors and text patterns without manual reprogramming, thus improving scalability and maintenance. The prompt generation mechanism, by embedding explicit operation types and format constraints, reduces ambiguity in generative AI responses, enabling the server to interpret and apply responses as structured commands. This combination leads to improved reliability of automated data transformations and more efficient use of computing and networking resources.

In one alternative embodiment, the server uses a different neural network architecture for classification, such as a convolutional neural network applied to character-level encodings of vendor names or a recurrent neural network for sequence modeling of OCR text. In another embodiment, the server locally hosts the generative AI model on dedicated hardware accelerators, such as a graphics processing unit or a specialized AI accelerator, to reduce latency and eliminate dependence on external inference services. In yet another embodiment, the server uses a hybrid expert system that combines rule-based logic with the outputs of the generative AI model, using confidence thresholds and rule priority schemes to further increase robustness in safety-critical accounting scenarios.

In a further embodiment, the terminal performs part of the preprocessing. The terminal may apply basic image enhancement such as auto-focus, exposure control, and coarse binarization to reduce the size of the transmitted image and offload compute from the server. By doing so, the system reduces communication load and server-side processing, which results in faster end-to-end processing time. The server then performs more advanced distortion correction and region extraction on the received image. This division of labor between terminal and server contributes to an overall improvement of system performance.

In another embodiment, the server provides different levels of detail in prompt sentences depending on the type of operation. For initial accounting data generation, the server uses more descriptive prompts that include comprehensive transaction context and normative instructions. For routine corrections, the server uses shorter prompts that highlight only the changes requested by the user and the candidate matching records. By dynamically adjusting prompt complexity, the server balances inference cost and output quality of the generative AI model, thereby improving computational efficiency.

In all embodiments, the server, the terminal, and the user interact through specific data structures and processing sequences that are tailored to the technical environment of image capture, network transmission, OCR, machine learning-based classification, and generative AI-based reasoning, rather than relying on generic manual steps. The server thus achieves a specific technical improvement in how computing systems transform and manage financial document images and related natural language inputs into reliable, structured accounting and tax data.

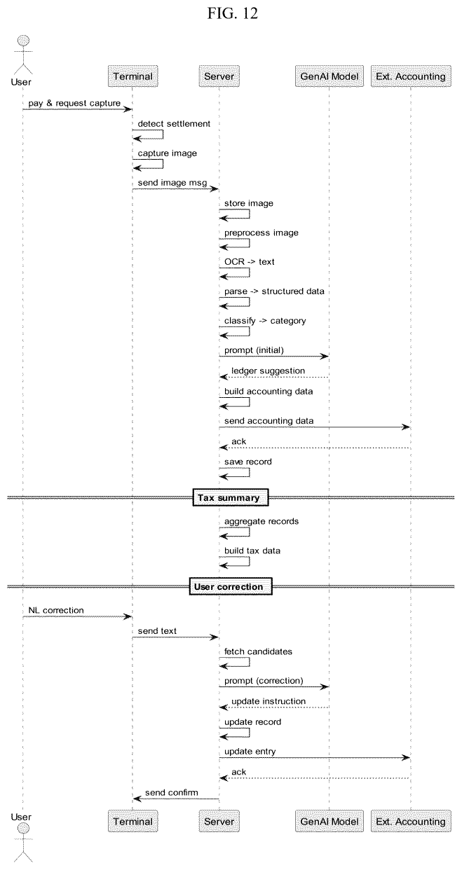

The following describes the processing flow using FIG. 12.

### Step 1:

The terminal detects a settlement event. The terminal receives, as input, an event notification from a payment application or an operating system service indicating that a financial transaction has been completed (for example, a card payment approval). The terminal checks event attributes such as timestamp, merchant identifier, and transaction amount, and verifies that the event type matches a configured “payment completed” type. As output, the terminal produces an internal trigger signal that starts the capture process for transaction evidence information.

### Step 2:

The terminal controls an imaging device to capture transaction evidence information. The terminal receives, as input, the trigger signal from Step 1 and camera configuration parameters such as resolution, focus mode, and exposure. The terminal activates the camera hardware, displays a preview on the screen, and adjusts focus and exposure using autofocus and auto-exposure algorithms provided by a camera API. The terminal then captures a still image of a receipt or other transaction evidence document. As output, the terminal generates raw image data (for example, a high-resolution color frame) and metadata including capture time and device orientation.

### Step 3:

The terminal compresses and packages the image for transmission. The terminal receives, as input, the raw image data and metadata from Step 2. The terminal performs data processing that includes image compression (for example, JPEG encoding), optional downscaling to reduce pixel dimensions, and embedding of basic metadata. The terminal then attaches the compressed image to a message in a communication application, optionally adding a short text note such as “Receipt for lunch.” As output, the terminal produces a message object that includes the compressed image payload and associated text, ready to be sent over a network.

### Step 4:

The terminal transmits the message to the server via a communication application. The terminal receives, as input, the message object from Step 3 and network status information.

The terminal establishes or reuses a secure communication session with a messaging platform and sends the message using a protocol such as HTTPS. The terminal may retry transmission if network errors occur. As output, the terminal obtains a delivery acknowledgment from the messaging platform and a message identifier that can be used to correlate later responses.

### Step 5:

The server receives the message and stores the image data. The server receives, as input, a webhook or callback request from the messaging platform containing a message identifier, sender identifier, and a reference (URL or binary payload) to the image. The server parses the request body, authenticates the origin, and downloads the image data if only a reference is provided. The server then writes the image data to persistent storage (for example, a file system path or an object storage key) and records an entry in a database containing the user identifier, storage location, and timestamps. As output, the server produces a stored image record that links the user and the captured transaction evidence.

### Step 6:

The server performs image preprocessing on the stored image. The server receives, as input, the stored image record and loads the image data into an image processing library. The server executes a sequence of data transformations: resolution correction by resampling the image to a target pixel density; noise reduction by applying filters to smooth random pixel variations; contrast correction by adjusting intensity distributions; binarization by thresholding grayscale values; distortion correction by estimating and compensating for skew and perspective; and region extraction by identifying and cropping the main document area. These operations convert the raw image into a normalized representation optimized for text recognition. As output, the server produces a preprocessed image along with updated metadata indicating applied transformations.

### Step 7:

The server executes character recognition on the preprocessed image. The server receives, as input, the preprocessed image from Step 6. The server passes the image to an OCR engine configured with language models and page segmentation settings. The OCR engine analyzes pixel patterns, segments text regions, and matches glyph shapes to character models. The server collects the recognized text lines and, optionally, bounding box coordinates for each line. As output, the server generates text information that consists of one or more strings representing the content of the receipt, and stores this text in association with the image record.

### Step 8:

The server parses the recognized text into structured data. The server receives, as input, the text information from Step 7. The server applies tokenization to divide the text into words and numbers, and uses pattern-matching rules (for example, regular expressions) to detect a transaction date, monetary amounts, and document headers. The server converts date strings into a normalized date format, selects the most probable total amount by locating numbers near keywords such as “Total,” and extracts a transaction entity by analyzing the first lines and filtering out generic labels. The server also derives a transaction type by searching for phrases that indicate purchase, refund, or fee. As output, the server produces structured data records that include fields such as date, amount, transaction entity, transaction type, and references to the original text and image.

### Step 9:

The server classifies the transaction into an expense category. The server receives, as input, the structured data and OCR text from Step 8. The server converts the structured data into a feature vector, including numerical features (such as normalized amount), categorical features (such as encoded transaction type), and textual features (such as token embeddings for the transaction entity and specific lines). The server feeds the feature vector into a trained classification model, which computes scores for multiple candidate categories using learned weights and an activation function such as softmax. The server selects the category with the highest score and records a confidence value. As output, the server appends an estimated expense category and confidence score to the structured data.

### Step 10:

The server generates a prompt sentence for initial accounting processing. The server receives, as input, the structured data and the estimated expense category from Step 9. The server constructs a prompt sentence in natural language that describes the transaction fields and instructs a generative AI model to propose an accounting treatment. The server embeds key values such as date, amount, entity, type, and candidate category into a textual template. For example, the server may generate:

“From the following transaction information, determine how it should be recorded in the accounting ledger.
Transaction date: 2023 Oct. 5
Amount: 500 JPY
Entity: STORE ABC
Type: purchase
Candidate expense category: Office Supplies

Describe the appropriate journal entry and confirm the expense category in plain text.”

The server outputs the completed prompt sentence as input for further processing by the generative AI model.

### Step 11:

The server obtains a response from the generative AI model and generates accounting data.

The server receives, as input, the prompt sentence from Step 10. The server transmits this prompt sentence to a generative AI model interface, which returns a natural language response describing journal entries and category decisions. The server parses the response text by searching for account names, debit and credit indications, amounts, and category confirmations or adjustments. The server then constructs accounting data structures that include journal information (debit account, credit account, amount), final expense category, and attributes useful for tax return preparation. As output, the server produces normalized accounting data for the transaction.

### Step 12:

The server synchronizes accounting data with an external accounting service and stores local records. The server receives, as input, the accounting data from Step 11. The server maps internal fields to the external service's schema, formats dates and amounts according to the external specification, and generates a structured message for an application programming interface. The server sends this message through a communication interface and receives a result indicating success or failure and any external identifiers. The server writes the accounting data, along with external identifiers and synchronization status, into a storage device such as a database. As output, the server maintains a persistent, synchronized accounting record associated with each transaction.

### Step 13:

The server derives tax return data from stored accounting data. The server receives, as input, a set of accounting data records filtered by period and user. The server aggregates amounts by categories that correspond to tax form lines, applies rules that distinguish deductible and non-deductible items, and computes subtotals required by a tax authority's return format. The server assembles these values into a data structure whose fields correspond to items on a tax return form. As output, the server produces tax return data that can be exported or presented for filing.

### Step 14:

The user issues a natural language inquiry or correction request through the terminal. The user receives, as input, a need to verify or modify accounting records, such as noticing that a receipt has been miscategorized. The user opens the communication application on the terminal and composes a message in natural language, for example: “Please change today's 500 yen receipt at STORE ABC to category Travel.” The user sends this message to the server. As output, the user produces a text message that the terminal forwards through the communication application.

### Step 15:

The server constructs an additional prompt sentence based on the user's request and current accounting data. The server receives, as input, the user's natural language message from Step 14 and current accounting data from the database. The server searches for candidate transactions that match the details mentioned in the user's message, such as date, amount, and entity. The server then creates an additional prompt sentence that includes the user's instruction and a summarized list of candidate transactions, while specifying that only listed transactions may be modified. For example, the server may generate:

“You are a tool that manages expense records.

User instruction: ‘Please change today's 500 yen receipt at STORE ABC to category Travel.’ Current transactions:
1) ID: tx_001, date: 2023 Oct. 5, entity: STORE ABC, amount: 500 JPY, category: Office Supplies

Identify which transaction should be updated and state the new category in plain text.”

The server outputs this additional prompt sentence as the input for the generative AI model in the correction phase.

### Step 16:

The server interprets the generative AI model's response and updates accounting data. The server receives, as input, the additional prompt sentence from Step 15 and a natural language response from the generative AI model. The server parses the response to determine which transaction identifier is referenced and what new category or other changes are requested.

The server then updates the corresponding record in the database by modifying relevant fields, such as changing the category from “Office Supplies” to “Travel,” and marks the change with a timestamp and user reference. If the record is synchronized with an external accounting service, the server also issues an update request to that service. As output, the server produces updated accounting data and logs the performed operations for later auditing.

### Step 17:

The server notifies the terminal of the update result. The server receives, as input, the status of the update operations from Step 16. The server formats a confirmation message for the user, summarizing the change, such as: “The 500 JPY transaction at STORE ABC on 2023 Oct. 5 has been updated to category Travel.” The server sends this message through the communication application interface to the terminal. As output, the server generates a human-readable confirmation, and the terminal displays this confirmation to the user.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented tax preparation workflows require a user to manually transcribe data from paper or image-based vouchers into structured fields of tax declaration forms. In typical systems, an image processing component and an optical character recognition component merely output raw or semi-structured text, and subsequent mapping of that text to machine-usable tax data structures is performed through rigid, rule-based logic implemented in application code. Such rule-based logic is difficult to maintain across diverse voucher layouts, languages, and jurisdictions, and it tends to fail when document formats change or when the OCR output contains minor errors. As a result, the processor frequently produces incomplete or inconsistent tax data, leading to repeated manual corrections, increased latency, and a higher computational load due to multiple passes of validation and error handling.

Furthermore, conventional systems provide only limited support for natural language interaction. When the user identifies an error in the automatically generated tax data, the user typically must edit discrete fields (for example, by typing corrected numbers into form fields) rather than giving a single high-level natural language instruction. Existing systems do not effectively integrate natural language correction instructions with the internal structured data, and do not leverage generative AI models in a systematic, prompt-driven manner for both initial structuring and subsequent correction of tax data. In addition, conventional architectures often treat the generative AI model as a generic text generator, without constraining outputs to well-typed, machine-validated data structures, thereby requiring ad hoc post-processing and undermining reliability.

Still further, traditional tax support systems do not exploit coordinated prompt sentence construction as a core computational mechanism. They do not adapt prompts based on the current state of structured data, validation results, and user feedback, and therefore cannot efficiently offload complex mapping and reconciliation tasks to advanced generative AI models. This leads to increased complexity in the server-side code base, duplicated logic between rule-based parsing and AI-based processing, and suboptimal use of computational resources.

Accordingly, there is a need for a computer-implemented technique that improves the way a processor acquires voucher images, performs image preprocessing and character recognition, transforms extracted text into structured tax declaration data by means of dynamically generated prompt sentences for a generative AI model, and applies natural language corrections from the user terminal in a controlled update cycle. There is a further need for a processor that reduces the reliance on brittle, hard-coded rules and instead uses a prompt-driven pipeline tightly integrated with validation and database storage, thereby improving robustness, adaptability, processing efficiency, and the overall quality of tax declaration data generated by the computing system.

The specific processing by the specific processing unit 290 of the data processing device 12 in Example 2 is realized by the following means.

The present invention provides a server comprising a processor configured to receive, via a communication apparatus, voucher images for tax processing and to perform preprocessing on the voucher images including pixel conversion processing and quality correction processing; to perform character recognition processing on the preprocessed voucher images to extract character information included in the voucher images as text data, and to normalize the text data; to generate a prompt sentence including an instruction statement that specifies items of an income declaration data structure and the normalized text data, and to input the prompt sentence to a generative AI model so as to cause the generative AI model to convert the text data into structured data in a tax declaration format; to analyze structured data output from the generative AI model, verify a numerical format and a date format in the structured data, record the structured data in a database, and convert the structured data into form data corresponding to a predetermined tax declaration form; to transmit, in response to a request from a user terminal, the structured data or the form data to the user terminal and provide the structured data or the form data as data for display and confirmation on the user terminal; to generate a prompt sentence including a correction instruction in natural language received from the user terminal and the structured data, and to input the prompt sentence to the generative AI model so as to cause the generative AI model to generate updated structured data in which only part of items of the structured data are updated based on the correction instruction, and to update the database with the updated structured data; and to generate final declaration data including an electronic submission data format or an image document format based on the updated structured data and provide the final declaration data to the user terminal. This enables an improved computer-implemented tax processing workflow in which the processor systematically leverages a generative AI model through structured prompt sentences to transform OCR text into validated, database-backed tax declaration data, to apply user-provided natural language corrections as constrained updates to such data, and to output final tax declaration documents with reduced rule-based complexity, increased robustness to input variation, and enhanced efficiency in the overall data processing pipeline.

The term “communication apparatus” refers to a hardware and/or software component that enables data communication between a server and a user terminal over a network, and that is configured to transmit and receive messages including image data, structured data, and control information using one or more communication protocols.

The term “voucher image” refers to digital image data that visually represents a document evidencing a transaction or income, such as a receipt, statement, or certificate, and that is used as a source for extracting information for tax processing.

The term “tax processing” refers to a series of computer-implemented operations for preparing, validating, and generating data and documents used for filing or supporting a tax declaration with a tax authority.

The term “preprocessing” refers to one or more image processing operations performed on a voucher image before character recognition, including but not limited to resizing, pixel conversion, noise reduction, orientation correction, and contrast enhancement.

The term “pixel conversion processing” refers to a type of image processing that transforms pixel values in a voucher image, such as converting a color image to a grayscale image, adjusting brightness or contrast, or changing the resolution.

The term “quality correction processing” refers to an image processing operation that improves the visual clarity of a voucher image for subsequent recognition, including correction of skew, deblurring, denoising, and enhancement of character edges.

The term “character recognition processing” refers to an automated computational technique for analyzing a voucher image to detect and recognize characters, and for outputting corresponding digital character codes as machine-readable text data.

The term “text data” refers to digital data composed of character codes representing letters, numerals, and symbols extracted from a voucher image, and capable of being processed by software components such as parsers, validators, and generative AI models.

The term “normalize the text data” refers to processing operations on text data to unify its format, including removal of extraneous characters, standardization of whitespace, conversion of character types, normalization of numerical and date representations, and alignment of labels and values.

The term “prompt sentence” refers to a structured textual input that includes an instruction statement and associated data, and that is supplied to a generative AI model to cause the generative AI model to perform a specific processing task.

The term “instruction statement” refers to a portion of a prompt sentence that explicitly describes the task to be performed by a generative AI model, such as extracting fields, formatting data, updating values, or generating advisory information.

The term “income declaration data structure” refers to a predefined logical arrangement of fields representing information used in an income tax declaration, including identifiers, income amounts, deductions, taxes, and dates.

The term “generative AI model” refers to a machine-learned computational model configured to generate text or structured outputs in response to input text, and that can perform tasks such as information extraction, data transformation, and natural language understanding based on training on large-scale data.

The term “structured data in a tax declaration format” refers to data that is organized according to a predefined schema or set of fields used for tax declaration, such that each item of information is represented by a field name and a value compatible with tax processing.

The term “structured data” refers to data that is organized into a defined set of fields, records, or elements with explicit semantics and formats, thereby enabling systematic storage, validation, retrieval, and processing by database and application components.

The term “numerical format” refers to a representation of numeric values in the structured data, including integers, decimals, and currency amounts, that conforms to predetermined rules regarding character sets, decimal separators, and ranges.

The term “date format” refers to a representation of calendar dates in the structured data that conforms to a predetermined pattern, such as year-month-day, and that is suitable for computational comparison, validation, and display.

The term “database” refers to a persistent data storage system implemented using a database management system, in which structured data and updated structured data are recorded, indexed, and managed for subsequent retrieval and processing.

The term “form data” refers to structured data that has been formatted or mapped to correspond to fields and layout elements of a predetermined tax declaration form template.

The term “tax declaration form” refers to a predefined set of fields, layout, and instructions prescribed for submitting tax-related information to a tax authority, and that serves as a template for generating documents or electronic submissions.

The term “user terminal” refers to an information processing apparatus operated by a user, such as a computing device or communication device, that is configured to send voucher images and instructions to the server and to receive and display structured data, form data, and final declaration data.

The term “data for display and confirmation” refers to structured data or form data that is formatted for presentation on a user terminal so that a user can visually review and verify the correctness of the data.

The term “correction instruction in natural language” refers to a user-provided message expressed in a human language that specifies changes, updates, or confirmations to one or more fields of the structured data.

The term “updated structured data” refers to structured data that has been modified from an earlier version to reflect one or more corrections or additions, while maintaining a defined schema and format.

The term “electronic submission data format” refers to a data representation suitable for electronic filing with a tax authority, such as a structured file format defined by an electronic submission specification.

The term “image document format” refers to a representation of a document as an image-based file, such as a rasterized page or a document container that includes rendered pages, suitable for visual inspection or printing.

The term “final declaration data” refers to data generated from updated structured data that is ready for submission or presentation as a completed tax declaration, including but not limited to electronic submission data formats and image document formats.

The term “interactive screen for natural language input” refers to a user interface displayed on a user terminal that enables a user to enter, transmit, and review natural language messages for confirming or correcting structured data.

The term “natural language processing” refers to computational techniques for analyzing, interpreting, and structuring input expressed in a human language so that the input can be used programmatically to update or manage data.

The term “analysis result” refers to data derived from processing a natural language instruction, including identified target fields, values, and relationships, which can be used to construct a prompt sentence or update structured data.

The term “automatic correction and completion of the structured data” refers to a process in which a generative AI model modifies and supplements structured data based on instructions and context, without requiring the user to manually edit each individual field.

The term “external knowledge provision apparatus” refers to an external system or service that supplies domain-specific information, such as tax rules or guidelines, that can be used to generate or refine advisory information.

The term “external decision support apparatus” refers to an external system or service that performs reasoning or evaluation based on input data to support recommendations or decisions related to tax processing.

The term “advisory information” refers to information generated on the basis of structured data and possibly external knowledge, including recommendations, warnings, or explanations that assist a user in making tax-related decisions.

In one embodiment, a server cooperates with a terminal operated by a user to implement a tax processing system that converts voucher images into validated tax declaration data and final declaration documents by using a generative AI model controlled through prompt sentences. The server executes one or more software programs on hardware including at least one processor, a main memory, a storage device such as a solid-state drive, and a network interface. The terminal comprises a general-purpose computing device such as a smartphone, tablet, or personal computer equipped with a display, a camera, local storage, and a communication module.

The server executes an application program built on a web framework such as a hypertext transfer protocol server framework (for example, an HTTP server with a server-side application framework) running on an operating system such as a general-purpose server operating system. The server executes an image processing library such as an OpenCV-type library or a Pillow-type library, an optical character recognition engine such as a Tesseract-type OCR engine or a cloud-based OCR service, a database management system such as a relational database engine, a PDF generation library such as a ReportLab-type or PDFBox-type library, and a client library for accessing a remote generative AI service. The generative AI service executes a generative AI model, such as a transformer-based large language model, on computing hardware that includes graphics processing units and high-capacity memory.

The terminal executes a communication application such as a messaging client or a dedicated tax application. The terminal uses the communication application to capture voucher images and to present structured data and form data for user confirmation and correction. The user operates the terminal to capture images of paper vouchers, to send the captured images to the server, and to provide natural language instructions such as corrections or confirmations.

The server receives voucher images from the terminal via a communication apparatus such as a secure network interface implementing transport layer security. The server stores each received voucher image as image data in a file system on a storage device. The server executes an image processing module that loads the image data into memory and applies preprocessing operations including pixel conversion processing and quality correction processing. The server converts a color image into a grayscale image, adjusts brightness and contrast, corrects skew and rotation by detecting edges and baselines, and performs noise reduction by applying filters to remove background artifacts. The server uses such preprocessing to improve the legibility of characters in the voucher image and to increase the accuracy of subsequent character recognition.

The server executes a character recognition module that uses an OCR engine to detect and recognize characters in the preprocessed voucher image. The server supplies the preprocessed image as input to the OCR engine with configuration parameters specifying language models, character sets, and page segmentation modes. The OCR engine analyzes pixel patterns, segments them into regions, lines, and characters, and outputs recognized characters as text data. The server receives the text data and stores it in memory and the database, and the server executes a normalization module that converts the text data into a normalized form.

The server removes extraneous whitespace and control characters, standardizes character encodings, unifies numeral formats and date formats, and aligns labels and values by applying regular expressions and dictionary-based mappings.

The server constructs specific data structures for internal data handling. The server stores voucher-level information in a voucher record that includes a voucher identifier, a user identifier, an image file path, a text field storing normalized text data, and a status field indicating processing stages. The server stores structured tax data in a tax data record that includes fields such as payer name, recipient name, multiple income-related fields, multiple deduction-related fields, withholding amounts, and payment dates. The server stores both text data and structured tax data in a relational schema that enforces data types and constraints for numerical and date fields.

The server generates a prompt sentence to control a generative AI model in transforming normalized text data into structured data in a tax declaration format. The server executes a prompt generation module that assembles an instruction statement and the normalized text data into a single textual input. In one example, the server generates the following prompt sentence:

“Please analyze the following text extracted from a tax-related voucher and convert it into structured tax declaration data. Extract and return at least the following fields: payer_name, recipient_name, gross_income, deduction_amount, withholding_tax, and payment_date. Output the result as plain text with each field name followed by a colon and its value. Text: [normalized voucher text here].”

In another example, the server generates the following prompt sentence:

“You are a tax data formatter. Read the following text from a salary voucher and arrange it into an income tax declaration format. Provide values for the following items: payer_name, recipient_name, total_income_amount, total_deduction_amount, social_insurance_deduction, withholding_tax_amount, and payment_date. If a value is unknown, write ‘UNKNOWN’. Text: [normalized voucher text here].”

The server inputs the prompt sentence into a generative AI model implemented as a transformer-based neural network. In one embodiment, the generative AI model comprises multiple transformer layers, each transformer layer including a multi-head self-attention mechanism and a feedforward subnetwork with non-linear activation functions. The generative AI model uses learned token embeddings and positional encodings to represent text sequences and processes the prompt sentence token by token. The generative AI model has been trained on large corpora of text including financial documents, tax-related descriptions, and general-purpose text, using a training objective based on next-token prediction. During training, the generative AI model minimizes a loss function, for example a cross-entropy loss between predicted next-token probability distributions and ground truth tokens, and uses gradient-based optimization such as stochastic gradient descent with adaptive learning rate methods to update weight parameters. The generative AI model uses layer normalization, dropout, and other regularization techniques to stabilize training and prevent overfitting.

The server transmits the prompt sentence to the generative AI model through an application programming interface exposed by the generative AI service. The server uses a specific model identifier, temperature, and maximum token length as parameters for inference. The generative AI model processes the prompt sentence and generates an output sequence that represents structured data. The generative AI model uses attention weights to focus on parts of the normalized text that correspond to requested fields, and uses learned patterns to map natural language expressions and numeric tokens to field values. This mechanism allows the generative AI model to handle diverse voucher formats and label variations beyond a fixed ruleset.

The server receives the generated output as a text sequence and parses it to extract field-value pairs according to the format specified in the prompt sentence. The server executes a validator module that checks that fields expected to be numeric, such as gross income and deduction amounts, conform to a numerical format and that fields expected to be dates conform to an allowed date format. The server converts localized numeric formats to a standard representation and converts recognized dates to a normalized date string. The server performs consistency checks, for example verifying that certain totals equal the sum of component values within an allowed tolerance. When the validator module detects an inconsistency or parsing failure, the server can generate a revised prompt sentence that requests a corrected or more constrained output, and the server can re-query the generative AI model. Because the generative AI model is guided by explicitly structured prompt sentences and downstream validation criteria, the server can effectively constrain the model outputs to a data structure that the database can store with minimal manual intervention.

The server stores the validated structured data in the database associated with the corresponding voucher and user. The server then converts the structured data into form data corresponding to a predetermined tax declaration form. The server maps each data field to a specific position or field name in a form template stored in the storage device. The server generates human-readable labels and layout information in the form data so that the terminal can display a formatted view of the tax declaration to the user.

The terminal receives structured data or form data from the server through the communication application. The terminal parses the received data and renders an interface on the display, showing each field, such as payer name, recipient name, income amounts, and dates, in a tabular or form-like layout. The user reviews the displayed data and identifies errors or missing values, if any. The terminal presents an interactive screen for natural language input, such as a message input area or chat interface.

The user enters natural language instructions to correct or supplement the structured data. In one example, the user enters the following correction instruction:

“The gross income should be 5,200,000 instead of 5,000,000, and the deduction amount should be 700,000 instead of 600,000.”

In another example, the user enters:

“The payment date must be Mar. 31, 2025, not Mar. 30, 2025.”

The terminal sends the natural language correction instruction and a record identifier for the related structured data to the server. The server executes a correction prompt generation module that retrieves the current structured data from the database and constructs a new prompt sentence. In one example, the server generates the following prompt sentence: “You are updating structured tax data. Here is the current data: [current structured data text]. The user provides the following correction in natural language: ‘The gross income should be 5,200,000 instead of 5,000,000, and the deduction amount should be 700,000 instead of 600,000.’ Update only the mentioned fields and return the full set of fields with the corrected values.”

In another example, the server generates the following prompt sentence:

“Adjust the following tax data according to the user's instruction. Original data: [current structured data text]. User's instruction: ‘The payment date must be Mar. 31, 2025, not Mar. 30, 2025.’ Change only the payment_date field and keep all other fields unchanged.”

The server transmits the correction prompt sentence to the generative AI model, which again processes the prompt using its transformer layers. The generative AI model uses the correction instruction as a conditioning context and generates an updated set of fields. The model's self-attention mechanism computes attention weights that highlight tokens representing field names and values in the current structured data that are referenced by the instruction. The generative AI model learns to apply constrained updates because the prompt sentence explicitly instructs the model not to alter unspecified fields.

The server receives the updated structured data and parses it into field-value pairs. The server validates that only the intended fields have changed and that updated numerical and date values are in acceptable ranges and formats. The server then writes the updated structured data to the database and retains a log of changes for auditing. By using the generative AI model in this constrained update mode, the server reduces the complexity of the update logic and avoids the need to manually implement detailed parsing of free-form user instructions.

The server generates final declaration data by converting the latest updated structured data into an output format required by a tax authority or other external system. The server uses a PDF generation library to fill out a tax declaration form template with field values, or uses a configured schema to produce an electronic submission data file in a structured format. The server maps fields to visual positions or schema elements and performs any required rounding or formatting of amounts. The server then provides the final declaration data to the terminal, which allows the user to view, download, or transmit the final tax declaration.

The described configuration yields technical improvements beyond mere automation of human tasks. The server reduces the number of hard-coded rules and pattern-specific parsers by delegating complex mapping from unstructured text to structured tax data to a generative AI model guided by carefully constructed prompt sentences. This reduces code size and branching complexity in server-side software and improves maintainability when voucher formats change. The server reduces processing time because the generative AI model can extract and structure multiple related fields in a single inference call rather than requiring multiple sequential rule-based passes. The server improves accuracy because the generative AI model can leverage contextual information across the entire voucher text and can compensate for minor OCR errors by reasoning about likely values and structures, whereas conventional rule-based systems typically fail when labels are slightly altered or misrecognized.

The server improves data management by consistently storing all structured data in a predefined schema and by ensuring that each update produced through a generative AI model passes through a validation layer. The server reduces communication load by avoiding repeated transmission of large raw images and instead exchanging compact structured data and prompt sentences after the image upload phase. The server also provides a clear data flow and modular structure: an image acquisition and preprocessing module, an OCR module, a normalization module, a prompt generation module, a generative AI interaction module, a validation and storage module, a correction handling module, and a document generation module.

The generative AI model operates under training and inference regimes that differ from human decision-making. The generative AI model uses a neural architecture with many layers of learned weights, high-dimensional embeddings, and attention mechanisms that compute similarity scores between token representations. During training, the generative AI model minimizes a loss function with respect to millions or billions of parameters using iterative gradient updates, which yields a capability to generalize from seen examples to unseen voucher formats. The model uses token-level probabilities to determine which textual continuation best satisfies the constraints implied by prompt sentences. This process is not a direct codification of human rules, but a learned mapping embedded in a weight space that captures statistical patterns in large text corpora. Accordingly, the system uses a non-conventional, model-based processing pipeline that is technically distinct from traditional rule-based automation of human procedures.

The generative AI model can be varied across embodiments. In one alternative embodiment, the server uses a smaller generative AI model running on-premises to handle low-latency tasks, while a larger remote generative AI model handles complex vouchers and ambiguous instructions. In another embodiment, the server combines output from multiple generative AI models, such as a model specialized for numeric consistency and a model specialized for semantic extraction, and then merges their outputs via a resolver module.

The server may also vary the prompt generation strategy. In one variation, the server constructs hierarchical prompt sentences, where a first prompt produces an intermediate key-value mapping, and a second prompt refines the mapping into a tax authority-specific schema. In another variation, the server augments prompt sentences with additional context such as jurisdiction-specific tax rules or user profile information that is relevant for interpreting ambiguous fields, thereby reducing the need for user corrections and further improving processing efficiency.

The described embodiments demonstrate how the combination of OCR, structured prompt sentences, a transformer-based generative AI model, and a validation and storage pipeline implements a specific, technical improvement to computer-based tax data processing. The server achieves higher accuracy, greater robustness to input variability, improved processing speed, and simplified server-side code structure compared with systems that rely solely on deterministic, rule-based parsing or manual user input.

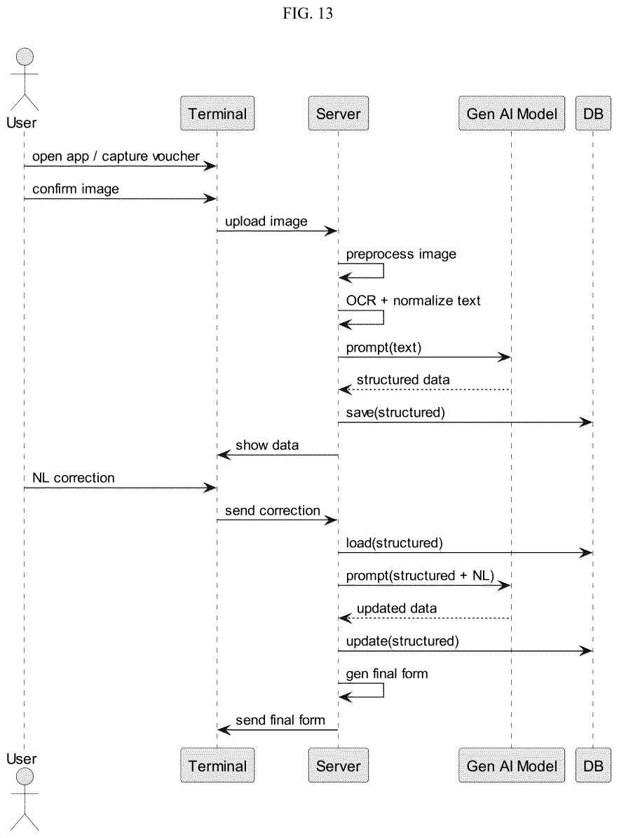

The following describes the processing flow using FIG. 13.

### Step 1:

The user operates the terminal to launch a communication application and to select or capture a voucher image.

The input is a physical voucher viewed by the user. The terminal activates camera hardware to capture the voucher as digital image data (for example, a JPEG file) or loads an existing image file from local storage. The terminal displays a preview of the image and allows the user to confirm or retake the image. The output is a confirmed voucher image stored in the terminal's local storage and registered in the communication application as a file ready for transmission.

### Step 2:

The terminal transmits the confirmed voucher image to the server via a network. The input is the voucher image file and associated metadata such as a user identifier and timestamp. The terminal encapsulates the image and metadata in an HTTP or HTTPS request (for example, multipart/form-data) and sends the request to a server endpoint. The output is a network message containing the image data that arrives at the server's communication interface.

### Step 3:

The server receives the voucher image and stores it in persistent storage.

The input is the network request including the image data and metadata. The server parses the request, extracts the binary image stream, and writes the image to a file system on a storage device with a generated file path. The server also inserts a record into a database, associating the file path with the user identifier and an initial processing status. The output is a stored image file and a voucher record in the database marked as “received.”

### Step 4:

The server performs preprocessing on the received voucher image using image processing software.

The input is the stored voucher image loaded into main memory. The server uses an image processing library (for example, an OpenCV-type or Pillow-type library) to execute pixel conversion (such as converting from color to grayscale), quality correction (such as denoising and sharpening), rotation and skew correction, and contrast enhancement. The server modifies pixel values according to filter kernels and transformation matrices to improve text visibility. The output is a preprocessed voucher image stored in memory or as a secondary image file, and the voucher record is updated to indicate “preprocessed.”

### Step 5:

The server performs character recognition processing on the preprocessed voucher image using an OCR engine.

The input is the preprocessed voucher image and OCR configuration parameters such as language settings and page segmentation mode. The server passes the image to an OCR engine (for example, a Tesseract-type engine or a cloud OCR service). The OCR engine segments the image into text blocks, lines, and characters, classifies character shapes into character codes, and returns recognized text. The server concatenates and organizes the recognized text into a unified text string or structured text representation. The output is raw text data that represents characters detected in the voucher, and the voucher record is updated with this raw text.

### Step 6:

The server normalizes the text data extracted from the voucher image.

The input is the raw text data from the OCR engine. The server uses string processing functions and pattern-matching rules (for example, regular expressions) to remove extraneous whitespace, normalize character encodings, and unify numerical representations (such as converting localized numerals to standard digits). The server detects date patterns and amount patterns and converts them into standardized formats. The output is normalized text data stored in the database, and the voucher record is updated to indicate “text normalized.”

### Step 7:

The server generates a first prompt sentence to instruct a generative AI model to convert normalized text into structured tax data.

The input is the normalized text data and a predefined income declaration data structure specification. The server constructs a prompt sentence that combines an instruction statement with the normalized text. The server inserts field names and formatting rules into the instruction so that the generative AI model will output a predictable structure. For example, the server may generate the following prompt sentence:

“Please analyze the following text extracted from a tax-related voucher and convert it into structured tax declaration data. Extract and return at least the following fields: payer_name, recipient_name, gross_income, deduction_amount, withholding_tax, and payment_date.

Output each field on a separate line in the format ‘field_name: value’. Text: [normalized voucher text here].”

The output is a fully constructed prompt sentence stored in memory and ready to be sent to the generative AI model.

### Step 8:

The server sends the first prompt sentence to a generative AI model and receives generated structured data.

The input is the prompt sentence and model parameters such as model identifier, temperature, and maximum output length. The server sends an API request to a generative AI service, which executes a transformer-based neural network. The model tokenizes the prompt sentence, applies multiple transformer layers with self-attention and feedforward operations, and generates an output token sequence that encodes structured field-value pairs according to the requested format. The server receives the generated text from the API response. The output is generated structured data expressed as text containing field names and values as specified in the prompt sentence.

### Step 9:

The server parses and validates the structured data output by the generative AI model.

The input is the generated text of structured data. The server parses the text by splitting lines, extracting field names and values, and mapping them to internal field identifiers. The server converts values expected to be numeric into numerical types and converts date strings into a standardized date format. The server checks that amounts are non-negative and that dates conform to a predefined date pattern. If inconsistencies are detected, the server may log errors or generate an adjusted prompt for re-querying. The output is validated structured tax data in internal data structures, and the database is updated with this structured data and a status such as “structured data ready.”

### Step 10:

The server transforms the structured tax data into form data corresponding to a tax declaration form template.

The input is the validated structured tax data and a stored form template definition. The server maps each field in the structured data to a corresponding logical field in the form template. The server converts numerical values into formatted strings with appropriate digit grouping and decimal symbols, and it assigns label texts for display. The output is form data that includes field identifiers, labels, and formatted values corresponding to the tax declaration form, and the record is updated to indicate that form data is available.

### Step 11:

The server transmits the structured data or form data to the terminal for user confirmation. The input is the structured data or form data and a user identifier or session identifier. The server encapsulates the data in a response message and sends it to the terminal via the communication apparatus. The terminal receives the message, parses the data, and renders a user interface displaying each field, such as payer name, income amount, deduction amount, and payment date. The output is a displayed tax data view on the terminal screen that the user can visually inspect.

### Step 12:

The user reviews the displayed tax data on the terminal and identifies corrections or additions.

The input is the rendered tax data view on the terminal display. The user compares the displayed information with the original voucher or personal records and mentally determines whether values are correct or need adjustment. The user then prepares a natural language instruction describing required corrections or missing information. The output is a human-generated correction or confirmation concept that the user is ready to input through the terminal.

### Step 13:

The user enters a natural language correction instruction on the terminal.

The input is the user's intention to correct specific fields. The terminal provides an input field or message interface where the user types a sentence such as: “The gross income should be 5,200,000 instead of 5,000,000, and the deduction amount should be 700,000 instead of 600,000.” The terminal associates this instruction with the corresponding voucher or tax data record identifier. The output is a digital text message containing the natural language correction instruction and record identifier stored within the communication application.

### Step 14:

The terminal sends the natural language correction instruction to the server.

The input is the text of the natural language instruction and the related record identifier. The terminal constructs a request message (for example, a JSON-based API call) and transmits it via HTTPS to the server. The output is a network request at the server side that contains the user's natural language correction instruction linked to the corresponding structured data record.

### Step 15:

The server generates a correction prompt sentence for the generative AI model based on the current structured data and the user's correction instruction.

The input is the current structured tax data retrieved from the database and the user's natural language correction instruction. The server formats the current structured data into a concise text representation and then composes a correction prompt sentence that instructs the generative AI model to update only specified fields. For example, the server may generate the following prompt sentence:

“You are updating structured tax data. Here is the current data: [current structured data text]. The user provides the following correction in natural language: ‘The gross income should be 5,200,000 instead of 5,000,000, and the deduction amount should be 700,000 instead of 600,000.’ Update only the mentioned fields and return all fields in the same format.” The output is a fully constructed correction prompt sentence that binds original structured values and user instructions into a single textual input for the generative AI model.

### Step 16:

The server sends the correction prompt sentence to the generative AI model and receives updated structured data.

The input is the correction prompt sentence and inference parameters for the generative AI model. The server transmits the prompt to the generative AI service. The generative AI model tokenizes the prompt, computes attention scores between tokens representing current fields and tokens representing the user's corrections, and generates an output sequence that contains a full set of fields with updated values where required. The server receives this updated structured data as text from the API response. The output is new structured data text that includes corrected values consistent with the user's instruction.

### Step 17:

The server parses, validates, and stores the updated structured data in the database. The input is the updated structured data text received from the generative AI model. The server parses field-value pairs as in the initial structuring step, converts numeric values and dates into internal formats, and verifies that only intended fields have changed according to the user's correction. The server checks for logical consistency, such as ensuring that totals remain coherent. The server then writes the updated values into the tax data record and creates an audit log entry recording the changes. The output is updated structured tax data persisted in the database and a status indicating “user-corrected.”

### Step 18:

The server regenerates form data and final declaration data based on the updated structured data.

The input is the updated structured tax data. The server remaps fields to the tax form template, regenerates form data, and then uses a PDF generation or structured file generation library to create final declaration data. The server fills template placeholders with the updated values, generates page layouts, and produces an output file in a prescribed format such as a PDF document or an electronic submission data file. The output is final declaration data stored in the server's storage and associated with the user's account.

### Step 19:

The server transmits the final declaration data to the terminal for user access.

The input is the final declaration data file path or binary representation and the user identifier.

The server either sends the file directly as a download response or sends a link from which the terminal can download the file. The terminal receives the response, downloads the final declaration file, and offers options to view, save, or share the file. The output is a final tax declaration document accessible on the terminal, enabling the user to review and, if desired, submit it to a tax authority.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented accounting and tax-processing systems require rigid, form-based input and rule-centric configuration. In many cases, a processor merely applies predefined mapping tables or business rules to financial data and produces static reports. Such systems exhibit several technical shortcomings from a computer-technology standpoint.

First, existing systems are not designed to efficiently ingest heterogeneous input data streams that combine image information, semi-structured transaction feeds, and unstructured natural-language messages. Image data such as receipts and certificates must typically be processed in separate tools, and the resulting text must be manually reconciled with database records. This fragmented pipeline forces repetitive data transfers between components and data models, thereby increasing memory usage, storage overhead, and latency on the server side. Second, although optical character recognition and basic image preprocessing are known, conventional systems do not tightly integrate these functions with higher-level machine reasoning in a way that allows a single processor to automatically transform raw vouchers into machine-usable accounting and tax-return structures. In particular, known systems do not define a unified, machine-usable “prompt sentence” representation that consistently encapsulates structured data, rule information, and output format constraints as input to a generative AI model. As a result, the generative AI model, if used at all, tends to operate as an isolated component, and the server must perform ad hoc pre- and post-processing in application code, which is not optimized for machine efficiency or reliability.

Third, conventional systems offer limited support for natural-language interaction that directly drives backend data operations. When a user issues a free-form correction or query—such as changing the date on a particular voucher or requesting a filtered summary—legacy architectures lack a robust mechanism for converting such natural-language instructions into deterministic, machine-actionable operations. Instead, human operators or complex, rule-based parsers must interpret the instructions, which introduces additional latency, error-prone logic paths, and duplicated code.

Fourth, existing systems generally ignore user emotion in the technical control loop. Even when sentiment or tone analysis is available, it is not integrated into the core processing pipeline as a first-class input that influences how the processor constructs prompts for the generative model, adjusts explanation depth, and manages iteration with the user. This omission results in inefficient user-system interaction: confused or frustrated users may cause repeated queries and corrections, consuming unnecessary processing cycles on both client and server, and increasing overall system load and response time.

Fifth, most current solutions fail to provide a coherent, end-to-end control flow in which the same processor coordinates (i) image preprocessing and OCR, (ii) structured-data generation, (iii) dynamic prompt construction for a generative AI model, (iv) AI-assisted accounting and tax mapping, (v) natural-language intent interpretation, and (vi) emotion-aware response generation, all while maintaining consistency in stored accounting and tax-return data. Instead, multiple loosely coupled modules must be stitched together, causing additional inter-module communication overhead, redundant parsing, and schema conversion steps, which degrade throughput and scalability.

Accordingly, there is a need for an improved computer-implemented system in which a processor is configured to orchestrate these heterogeneous functions in an integrated manner. The system should (a) accept transaction-related image and structured data, (b) apply image and language processing to create normalized structured data, (c) construct and manage prompt sentences as a formal interface to a generative AI model, (d) use the generative AI model to generate and refine accounting and tax-return data, (e) interpret natural-language user instructions into precise backend operations, and (f) incorporate user emotion analysis into the prompt-generation and response-selection pipeline. By doing so, the system can reduce processing redundancy, decrease server-client round trips, provide more accurate and consistent accounting data, and improve the efficiency of user interaction from a computer-technology perspective.

The specific processing by the specific processing unit 290 of the data processing device 12 in Application Example 2 is realized by the following means.

The present invention provides a server comprising a processor configured to receive, via a communication apparatus, image information including transaction-related information or structured information, to perform preprocessing of the image information by using an image processing method, to extract character information from the preprocessed image information by using a character recognition method, to generate structured data including at least date-time information, amount information, transaction party information, and item information by applying a natural language processing method to the character information and the structured information, to generate, based on the structured data, a prompt sentence including content of accounting processing or tax processing, rule information to be applied, and output format information, to input the prompt sentence and the structured data to a generative information processing model to cause the generative information processing model to generate accounting data including at least journal information, expense category information, or declaration information, to store the generated accounting data in a storage device and automatically convert the accounting data into a tax return format or an expense management format, to aggregate the accounting data or the declaration information to generate a draft of a tax return document or a draft of an accounting report corresponding to a target period, to receive an instruction or an inquiry in a natural language from a user terminal, to use the natural language as a prompt sentence for the generative information processing model to analyze user intent, to execute, based on a result of the analysis, processing of searching, correcting, or reclassifying with respect to the accounting data or the draft of the tax return document, to apply an emotion analysis method to text information or voice information in the natural language to identify an emotional state of a user, to add additional information including the emotional state to a prompt sentence for the generative information processing model and to generate a response message in which a detail level and an expression format of explanation information or advice information are controlled according to the emotional state, and to transmit the response message and the draft of the tax return document or the draft of the accounting report to the user terminal and record the draft of the tax return document or the draft of the accounting report as finalized data based on approval information from the user. This enables technical improvement of computer-based accounting and tax-processing operations by unifying heterogeneous input handling, structured-data generation, prompt-based interaction with a generative AI model, intent-driven backend updates, and emotion-aware response control into a single coordinated processing flow, thereby reducing redundant data conversions, lowering processing latency, and increasing the reliability and usability of the system.

The term “communication apparatus” refers to a hardware and software combination that enables transmission and reception of digital data between a server and one or more terminals over a communication network, and includes, for example, network interfaces, communication protocols, and messaging applications.

The term “image information” refers to digital data representing a visual scene in which characters, symbols, or patterns related to transaction information are included, and encompasses, for example, still images or video frames of receipts, vouchers, invoices, statements, and certificates.

The term “transaction-related information” refers to information that specifies details of a commercial or financial transaction, including at least a date or time, an amount, a transaction party, and an item or category of goods or services.

The term “structured information” refers to information that is represented in a machine-readable format with explicitly defined fields or attributes, such as record-based data, tabular data, or hierarchical data structures, and that can be directly processed by a computer program without character recognition.

The term “image processing method” refers to a computational technique for transforming or analyzing image information, including, for example, operations such as noise reduction, contrast adjustment, rotation correction, cropping, resizing, or binarization, performed to improve the quality or interpretability of the image for subsequent processing.

The term “character recognition method” refers to a computational technique that analyzes image information to detect and identify characters or symbols, and converts them into digital text data, including, for example, optical character recognition.

The term “character information” refers to digital text data obtained by applying a character recognition method to image information, the digital text data including alphanumeric characters, symbols, or other glyphs that represent semantic content in a human language.

The term “natural language processing method” refers to a computational technique that analyzes text data expressed in a human language, and derives structured representations such as tokens, syntactic structures, semantic roles, entities, or intent from the text data.

The term “structured data” refers to data represented in a format in which each element is associated with predefined fields or attributes, such as key-value pairs, records, or objects, and that can be directly processed, queried, or stored by a database management system.

The term “date-time information” refers to data that specifies a point or interval in time, including one or more of a calendar date, a clock time, a time zone, or a period, and that is associated with a transaction or event.

The term “amount information” refers to data that specifies a numerical value associated with a transaction or item, including at least a monetary value and optionally a currency or a tax component.

The term “transaction party information” refers to data that identifies an entity involved in a transaction, including at least one of a payer, a payee, a vendor, a customer, or another counterparty, and that may include names, identifiers, or contact information.

The term “item information” refers to data that specifies a classification or description of goods or services involved in a transaction, including, for example, categories, item names, or expense types.

The term “prompt sentence” refers to a machine-constructed or user-provided text sequence that instructs a generative information processing model to perform a specific operation, the text sequence including, for example, task description, rule information, and output format constraints.

The term “accounting processing” refers to a computational operation that interprets transaction-related information and transforms it into accounting data, such as journal entries, account assignments, or financial statement elements, in accordance with predefined accounting rules or standards.

The term “tax processing” refers to a computational operation that interprets transaction-related or accounting information and maps it to tax-related categories, amounts, or forms in accordance with applicable tax rules or regulations.

The term “rule information” refers to data that specifies one or more constraints, conditions, or procedures that govern accounting processing or tax processing, including, for example, business rules, accounting standards, or tax regulations.

The term “output format information” refers to data that defines a structure, layout, or encoding to be used when generating output data, including, for example, formats of tax-return documents, expense reports, or machine-readable records.

The term “generative information processing model” refers to a computational model that, in response to an input including at least a prompt sentence and structured data, generates new data such as text, structured records, or classifications, by using a parameterized architecture trained on large-scale data.

The term “accounting data” refers to data representing financial information processed according to accounting rules, and includes, for example, journal entries, ledger entries, categorized expenses, income items, and balance information.

The term “journal information” refers to data representing one or more accounting entries each including at least an account identifier, a debit or credit attribute, an amount, and optionally a narrative or reference, suitable for recording in a ledger.

The term “expense category information” refers to data that associates a transaction or item with a particular expense classification, such as transportation, entertainment, supplies, or utilities, in accordance with accounting or tax rules.

The term “declaration information” refers to data that specifies content to be included in a tax declaration or similar filing, including at least income amounts, deductible expenses, and other tax-relevant values or identifiers.

The term “storage device” refers to a physical or virtual data storage resource capable of persistently storing digital information, including, for example, a disk drive, a solid-state memory, or a network-based storage service, typically managed by a database management system.

The term “tax return format” refers to a data structure or layout corresponding to one or more official or standardized tax return documents, in which tax-relevant values are placed into predetermined fields in accordance with tax authority specifications.

The term “expense management format” refers to a data structure or layout used for organizing, summarizing, or reporting expenses, including, for example, categorized expense lists, time-based aggregates, or budget comparisons.

The term “tax return document” refers to a representation, in human-readable or machine-readable form, of a tax declaration prepared for submission to a tax authority, including at least sections for income, deductions, and tax computation.

The term “accounting report” refers to a representation of accounting data in a summarized or structured form, such as a financial statement, a trial balance, or a management report, prepared for analysis, review, or submission.

The term “target period” refers to a defined time interval, such as a month, a quarter, or a fiscal year, for which accounting data or declaration information is aggregated and reported.

The term “user terminal” refers to an information processing apparatus operated by a user, including, for example, a mobile communication device, a personal computer, or another network-connected computing machine that can transmit and receive data to and from the server.

The term “instruction in a natural language” refers to a command, request, or directive expressed in a human language, such as spoken or written phrases, that conveys a user's intention regarding processing of data.

The term “inquiry in a natural language” refers to a question or information request expressed in a human language, such as spoken or written phrases, that seeks clarification, explanation, or data retrieval.

The term “user intent” refers to a semantic representation of an operation or objective that a user desires a system to perform, inferred from an instruction or inquiry in a natural language.

The term “searching” refers to a computational operation that retrieves data from a storage device based on one or more conditions, filters, or keys derived from structured data or user intent.

The term “correcting” refers to a computational operation that modifies existing data stored in a storage device, such as updating a field value, to reflect a corrected or changed state.

The term “reclassifying” refers to a computational operation that changes the category, type, or mapping of a data item, such as reassigning an expense to a different expense category or account.

The term “emotion analysis method” refers to a computational technique that analyzes text information or voice information to determine an emotional state, such as confusion, frustration, or satisfaction, associated with a user.

The term “emotional state” refers to a representation of a user's affective condition, quantified or categorized as, for example, neutral, positive, negative, confused, angry, or anxious, based on emotion analysis.

The term “additional information including the emotional state” refers to metadata or control parameters appended to or associated with a prompt sentence or other data, the metadata or control parameters indicating the user's emotional state for use in adjusting processing or responses.

The term “response message” refers to a data structure containing text, and optionally other media, that is generated by the server and transmitted to the user terminal in reply to an instruction or inquiry, and that may include explanations, advice, confirmations, or requests for clarification.

The term “explanation information” refers to data that describes, in a human-understandable manner, the content, reasoning, or result of accounting processing, tax processing, or system behavior.

The term “advice information” refers to data that provides recommendations or guidance to a user regarding accounting treatment, tax treatment, or further actions to be taken.

The term “detail level” refers to a parameter indicating a degree of granularity or depth of information presented in explanation information or advice information, such as a high-detail step-by-step explanation or a concise summary.

The term “expression format” refers to a style or structure used when presenting explanation information or advice information, including, for example, tone, complexity of vocabulary, and arrangement of content.

The term “approval information” refers to data indicating that a user has confirmed, accepted, or authorized a particular state of accounting data, a draft tax return document, or an accounting report, and that may be recorded for audit or control purposes.

The term “finalized data” refers to data that has been confirmed or approved and is marked as complete or ready for submission or further use, with restrictions on further modification except under controlled conditions.

The term “context information” refers to information used to interpret or generate other data, including at least natural-language instructions or questions, stored accounting data, user attributes, or processing history associated with a particular transaction or session.

The term “intent analysis process” refers to a computational operation that interprets an instruction or inquiry in a natural language and outputs a structured representation of user intent, including operation type and associated parameters.

The term “inference process related to accounting processing” refers to a computational operation that, based on rules, patterns, or model parameters, derives conclusions or recommendations regarding accounting treatment, classification, or summarization of data.

The term “automatic correction” refers to a process in which a system modifies accounting data without requiring manual editing of individual fields, in response to user intent or detected inconsistencies.

The term “summarized display” refers to a presentation of accounting data in which detailed items are aggregated or abstracted into higher-level groups, metrics, or overviews for ease of understanding.

The term “knowledge processing apparatus” refers to an information processing resource that provides rule information, guideline information, or expert knowledge used to support or constrain accounting or tax-related decision-making.

The term “professional advice information” refers to advice information that is generated based on rule information, guideline information, or expert knowledge and that is suitable for use in professional accounting or tax decision-making.

In one embodiment, a server implements the claimed system as software executed on one or more processors and memories coupled to network interfaces and storage devices. The server includes a central processing unit, a main memory, a nonvolatile storage unit, and a network interface connected to a communication network. The server executes an operating system such as a general-purpose server operating system, and under the operating system the server executes application modules implementing image preprocessing, character recognition, natural language processing, emotion analysis, database management, and interaction with a generative AI model. The server stores program instructions and configuration data for these modules in the nonvolatile storage unit and loads them into main memory for execution.

A terminal operates as a client device and comprises a processor, a memory, a display unit, an input unit, an image capture unit, an audio input unit, and a communication unit. The terminal executes a communication application or messenger application, which may be implemented as a mobile application or a web-based application. The terminal provides a graphical user interface allowing a user to capture images of transaction vouchers, input natural-language messages, review generated accounting and tax-return data, and provide approvals. The terminal sends and receives messages to and from the server using a network protocol such as HTTP or HTTPS over the communication network.

A user operates the terminal to capture image information of receipts, invoices, or tax certificates, and to provide natural-language instructions and inquiries. The user uses the terminal's camera to obtain a digital image of a paper voucher and uses the communication application to transmit the image to the server. The user also enters natural-language text or speech such as “Change the date of this receipt to Oct. 1, 2023” or “Which of my expenses are tax deductible?” The terminal encapsulates such input in a message and transmits the message to the server through the communication unit.

The server uses an image processing module implemented with an image-processing library such as a general-purpose open-source computer vision library to perform preprocessing on received image information. The server converts color images to grayscale, applies noise reduction filters, adjusts contrast, performs binarization, and corrects skew angles by estimating text line orientation. The server resizes and crops images to focus on regions containing textual content. These transformations are applied using numeric operations on pixel matrices, thereby improving the signal-to-noise ratio for downstream character recognition. Because these operations are implemented as efficient vectorized routines, the server reduces the computational load of the subsequent character recognition stage and increases recognition accuracy, which in turn reduces the need for repeated processing and user corrections.

The server uses a character recognition module based on an optical character recognition engine such as an open-source OCR engine or a cloud-based OCR service to convert preprocessed images into character information. The server inputs preprocessed pixel data into a convolutional neural network or similar recognition model provided by the OCR engine. The model has been trained using supervised learning on labeled image-character pairs, where an error function such as cross-entropy between predicted and true character sequences is minimized by gradient-based optimization. The server receives recognized text as sequences of characters with associated confidence values and positional metadata. The server stores this text in a structured database table that also associates each text segment with the source image identifier and spatial coordinates. This structured representation allows later modules to correlate character spans with voucher regions such as date, amount, and vendor fields.

The server applies a natural language processing module to the recognized character information and any structured information obtained directly from electronic transaction feeds. The server uses a tokenization and parsing library such as a general-purpose NLP framework to split text into tokens and sentences, and to identify part-of-speech tags and phrase boundaries. The server then uses rule-based extractors and trained sequence-labeling models, such as bidirectional recurrent neural networks or transformer-based encoders, to recognize entities corresponding to date-time information, amount information, transaction party information, and item information. Feature vectors used in these models may include token embeddings, character-level embeddings, position indices, and contextual embeddings output by the encoder. Model parameters are trained offline using supervised learning on annotated financial documents, where the loss function measures label prediction errors and is minimized via stochastic gradient descent. By combining rule-based filters with learned models, the server generates structured data objects that capture the semantics of each voucher with higher precision and robustness than traditional pattern-matching alone.

The server constructs a prompt sentence for a generative AI model by combining structured data, rule information, and output format information into a controlled text representation.

The server uses a prompt generation module implemented as deterministic code that serializes structured fields into natural-language descriptions and adds explicit instructions and constraints. For example, the server creates a prompt sentence such as:

“You are a tax assistant. Convert the following transaction records into the standard income tax return format for Japan. For each record, determine income category, deductible expense category, and whether the expense is deductible. Return a machine-readable structure suitable for database insertion. Data: [list of transactions with date, amount, counterparty, and description].”

In another example, the server constructs a prompt sentence such as:

“You are an accounting system. From the voucher data below (date, amount, vendor, description), generate double-entry journal entries including debit account, credit account, amount, and narrative. Output a list of journal lines.”

The server treats such prompt sentences as a formal intermediate representation between internal structured data and the generative AI model. Because the prompt sentences encode both domain rules and output format constraints, the generative AI model can be driven to emit outputs that align with predefined database schemas and accounting conventions, thereby reducing post-processing complexity and error rates.

The server uses a generative AI model implemented as a transformer-based neural network with multiple self-attention layers, feed-forward layers, and layer normalization. The generative AI model receives tokenized versions of the prompt sentence and, in some embodiments, a linearized representation of the structured data appended to the prompt. The model parameters consist of weight matrices and bias vectors learned from large-scale corpora, with additional fine-tuning on accounting and tax-related text and structured-label pairs. During training, the model is optimized using an autoregressive objective that minimizes prediction error of the next token given the context, with a regularization scheme such as dropout and weight decay. The server executes inference by providing the prompt tokens to the model and sampling or decoding tokens using constrained decoding methods, such as beam search with constraints that require specific JSON-like structures or field labels. This constrained decoding is implemented as algorithmic logic external to the model that filters candidate token sequences according to syntactic and semantic templates. Because the generative AI model is used in conjunction with structured prompts and constrained decoding, the server avoids generic text generation and instead obtains machine-actionable accounting data. The server thereby converts unstructured voucher content into journal information, expense category information, and declaration information with reduced human intervention. This technical configuration improves the efficiency of the overall data pipeline: repeated parsing and mapping logic formerly implemented as ad hoc application code is replaced with a single generative model controlled by standardized prompt sentences, which decreases code complexity, reduces maintenance overhead, and makes the data flow more uniform.

The server stores the resulting accounting data in a storage device, for example using a relational database management system. The server creates normalized tables that hold transactions, accounts, classification labels, and mappings to tax-return fields. Foreign keys and indices are configured to optimize queries that aggregate data by period, entity, and category. Because the generative AI model already outputs data in a structure aligned with these tables, the server can write records directly without complex transformation logic, improving write throughput and reducing the frequency of database schema mismatches.

The server uses an aggregation module to construct drafts of tax return documents and accounting reports. The server executes SQL queries or equivalent data-aggregation routines to compute totals per income category, per expense category, and per reporting period. The server then maps the aggregated values to a data structure corresponding to tax return fields such as income lines, deduction lines, and tax calculations. In some embodiments, the server applies deterministic rule engines that enforce statutory thresholds and allocation rules. Because all intermediate data originates from a unified structured representation, the aggregation operations are implemented as efficient, set-based computations rather than multiple ad hoc loops, which yields improved performance on large datasets.

The server provides an interface for the terminal to submit natural-language instructions and inquiries. The user uses the terminal to send phrases such as “Show me my transportation expenses for last month” or “Change the date of this receipt to Oct. 1, 2023.” The server receives these phrases and forms a prompt sentence to request intent analysis from the generative AI model. For instance, the server may generate a prompt sentence such as: “Interpret the following user request and output the operation to perform in a structured form (operation type, filters, new values). Request: ‘Change the date of this receipt to Oct. 1, 2023.’ Context: current receipt identifier and current date.”

The server then uses the generative AI model to convert the free-form instruction into a specific operation description. This mapping is not merely a direct translation of a business rule but is a computational process that identifies intent categories and binds parameter values using the language understanding capabilities of the model. The server uses the structured operation description to execute database queries and updates. Because the generative AI model is integrated as a programmable component guided by prompt sentences, the server can interpret a wide variety of linguistic expressions using a single model, replacing multiple specialized parsers that would otherwise be required.

The server employs an emotion analysis module to further condition prompt sentences and to optimize interaction. The server feeds the text of user messages into a sentiment analysis model, which may be a classifier trained on labeled text containing emotion labels such as “confused,” “frustrated,” and “neutral.” The classifier may be implemented using a transformer encoder followed by a classification layer trained via cross-entropy loss. The server uses the resulting emotion label as metadata to adjust processing. For example, in the presence of confusion, the server adds explicit instructions into the prompt sentence for the generative AI model, such as “Provide a detailed, step-by-step explanation with minimal technical jargon.” In contrast, in the presence of a neutral or expert-like tone, the server may instruct the generative AI model to produce a concise summary. This dynamic adaptation based on emotion labels yields technical benefits: by tailoring explanations to the user's state, the server reduces the number of clarification rounds, thereby reducing total message traffic and CPU usage over time.

The server generates response messages and transmits them to the terminal. The response messages may include plain-language explanations of accounting treatments, summaries of tax-return drafts, and confirmations of data corrections. For instance, after updating a receipt date, the server may inform the user: “I have updated the date of your receipt to 2023 Oct. 1.” After generating a tax-return draft, the server may provide a high-level explanation produced via a prompt sentence such as:

“Summarize the following tax return data for the user in plain English. Explain which amounts have been included as income, which expenses have been treated as deductible, and any assumptions made.”

The server transmits the formatted explanation and document preview to the terminal, where the user reviews the contents. When the user sends an approval message, the server marks the associated records as finalized and restricts further modifications except under defined conditions. This state tracking is implemented with explicit status fields and triggers or application logic that prevent inconsistent updates, improving data integrity.

The described architecture improves computer technology in several ways. The server reduces redundant data conversions by using prompt sentences as a standardized interface between structured data and a generative AI model, thereby avoiding multiple incompatible intermediate formats. The server improves processing speed by applying vectorized image preprocessing and by aligning OCR outputs with downstream structured schemas, which reduces error correction cycles. The server increases accuracy of classification and tax mapping by combining learned neural models with rule-based checks, which reduce misclassification compared to purely manual or rule-only systems. The server optimizes network communication and CPU utilization by using emotion-conditioned responses to minimize repeated user queries. These improvements arise from specific technical configurations and data flows, rather than from merely automating a human accountant's decision-making at a high level.

In another embodiment, the server uses alternative models or algorithms while maintaining the same overall data flow. The server may employ different OCR backends, such as cloud-based recognition services, and may adjust image preprocessing steps to match their input requirements. The server may use alternative generative AI models, including sequence-to-sequence architectures with encoder-decoder structures, or models specialized for tabular data generation. The server may incorporate rule-based post-processing modules that verify numerical consistency of outputs from the generative AI model. For example, the server may check that debits and credits in generated journal entries sum to equal amounts and may request regeneration when discrepancies are detected. This feedback mechanism can be encoded as a rule that triggers another call to the generative AI model with an augmented prompt sentence explaining the inconsistency.

In yet another embodiment, the terminal performs part of the preprocessing or analysis. The terminal may run a local emotion analysis engine on voice and video signals using lightweight neural networks and transmit only emotion labels and extracted features to the server. This configuration reduces upstream bandwidth consumption and enhances privacy because raw audio and video are not continuously transmitted. The server remains responsible for final accounting and tax-return data generation but benefits from locally preprocessed context.

In a further embodiment, the server uses a distributed or cloud-based architecture. Multiple server instances share a common database cluster, and a load balancer assigns incoming requests based on current load and resource usage. The generative AI model may be hosted on a specialized accelerator-equipped node, such as a graphics processing unit server, while image preprocessing and OCR run on general-purpose compute nodes. The server coordinates the flow of data between these nodes via message queues or remote procedure calls. By parallelizing and isolating computationally intensive tasks, the system can handle larger transaction volumes without degradation in latency, which is a technical scalability improvement over monolithic single-node systems.

In all of these embodiments, the server, the terminal, and the user cooperate to implement an integrated pipeline in which unstructured and semi-structured financial information is transformed into structured accounting and tax-return data using specific combinations of image processing, character recognition, natural language processing, and generative AI modeling controlled by prompt sentences. The detailed module arrangements, data structures, and model behaviors described above allow a person skilled in the art to implement the invention and demonstrate that the invention provides concrete improvements to the functioning of computer systems in the domain of accounting and tax processing.

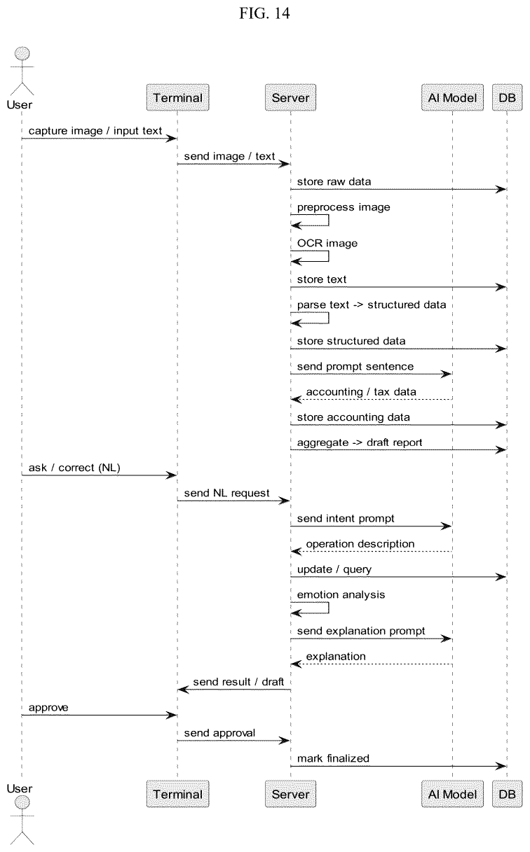

The following describes the processing flow using FIG. 14.

### Step 1:

User operates the terminal to capture and send source data.

User uses the terminal camera to capture an image of a receipt, invoice, or tax certificate, or selects existing transaction data from an electronic payment application. User also optionally enters a natural-language message such as “Here is my hotel receipt for last week.” Terminal packages the captured image data and any associated metadata (timestamp, approximate location, application identifier) as an image payload, and packages transaction records as structured payloads (for example, key-value pairs for date, amount, and merchant). Terminal then transmits these payloads to the server via a communication application over a network.

Input: raw image pixels and/or structured transaction records and optional natural-language text.

Output: network messages containing the image payloads, structured payloads, and text payloads addressed to the server.

### Step 2:

Server receives and persists raw payloads.

Server listens on a network interface for incoming HTTP or similar requests from the terminal. Server parses each request to determine the payload type (image, structured transaction data, or text). Server writes image payloads as binary objects into a file store or object store and inserts references into a database table together with metadata such as user identifier, capture time, and message identifier. Server writes structured transaction data into normalized database tables and stores text payloads as message records linked to the same user and timestamp.

Input: network messages containing image payloads, structured payloads, and text payloads from the terminal.

Output: database records referencing stored image files, persisted structured transaction records, and persisted text message records.

### Step 3:

Server performs image preprocessing on stored voucher images.

Server queries the database for newly stored image records that have not yet been processed. Server loads each referenced image file into an image-processing module and converts the color pixel matrix into grayscale. Server applies noise reduction (for example, Gaussian blur) and contrast enhancement, and then performs binarization to separate foreground text from background. Server estimates skew by detecting dominant line orientations and rotates the image so that lines of text become horizontal. Server crops margins and resizes the image to a canonical resolution suitable for character recognition.

Input: raw voucher images retrieved from storage.

Output: preprocessed image matrices stored as new files or in memory, together with updated database flags indicating that preprocessing is complete.

### Step 4:

Server extracts character information using a character recognition engine.

Server passes each preprocessed image matrix to an OCR engine, which internally applies a trained convolutional or sequence model to recognize character patterns. Server configures the OCR engine with language settings appropriate for the vouchers. Server receives recognized text lines, each consisting of character sequences with associated confidence scores and bounding box coordinates. Server normalizes line breaks, removes clearly erroneous characters based on confidence thresholds, and concatenates related lines into larger text fields. Server then writes these text fields and positional data into a database table associated with the original image record.

Input: preprocessed image matrices.

Output: character information consisting of text fields and positional metadata stored in a database.

### Step 5:

Server generates structured data from character information and existing structured feeds.

Server retrieves character information and any associated structured transaction feeds for the same user and approximate time period. Server tokenizes the text into words and numbers, and applies pattern recognition and natural language processing rules to identify candidate date expressions, numeric amounts, tax components, merchant names, and item descriptions.

Server uses trained sequence-labeling models or rule-based matchers to assign labels such as date-time information, amount information, transaction party information, and item information to spans of text. Server merges overlapping candidates and resolves conflicts (for example, selecting the most plausible date when multiple numeric patterns exist). Server then constructs structured data objects in which each field (date-time, amount, transaction party, item category, and others) is explicitly represented.

Input: recognized character information and optional structured transaction feeds.

Output: structured data objects representing parsed voucher content stored as records in structured database tables.

### Step 6:

Server constructs a prompt sentence for the generative AI model.

Server selects a group of structured data objects that require accounting or tax processing.

Server serializes these objects into a textual description using a deterministic formatting routine, including relevant fields such as date, amount, counterparty, and item category.

Server then generates a prompt sentence that combines this serialized description with explicit instructions and rule information. For example, server creates a prompt sentence: “You are an accounting system. From the voucher data below (date, amount, vendor, description), generate double-entry journal entries including debit account, credit account, amount, and narrative. Output a list of journal lines.”

Server appends the serialized voucher data to this instruction text.

Input: structured data objects representing parsed vouchers.

Output: prompt sentences that encode accounting or tax tasks together with embedded voucher data.

### Step 7:

Server invokes the generative AI model to generate accounting data.

Server sends each prompt sentence to a generative AI model endpoint, where the model is implemented as a transformer-based neural network. Server tokenizes the prompt sentence into subword tokens and transmits these tokens to the model. Server configures decoding parameters such as maximum output length and allowed token patterns. The generative AI model computes attention-based transformations to produce an output token sequence that encodes accounting data such as journal lines, expense categories, and declaration fields.

Server decodes the output tokens into text, validates the syntax against expected templates, and parses the output text into machine-readable fields such as debit account, credit account, and amount.

Input: tokenized prompt sentences.

Output: accounting data in parsed form, including journal information, expense category information, and declaration information.

### Step 8:

Server stores generated accounting data and converts it to reporting formats.

Server maps the parsed accounting data into relational tables representing transactions, journal entries, accounts, and tax mappings. Server inserts records using prepared SQL statements, updating foreign keys and indexes to maintain relational integrity. Server then executes aggregation queries to compute totals by period, account, and category. Based on configuration data representing tax-return formats and expense management layouts, server transforms the aggregated results into document structures that correspond to a tax return format or an expense management format, such as field-value pairs for each line of a tax form.

Input: parsed accounting data generated by the generative AI model.

Output: persisted accounting records and formatted tax-return or expense-management structures stored in the database.

### Step 9:

User issues natural-language instructions and inquiries through the terminal.

User reviews summaries or previews of accounting data and tax-return drafts presented on the terminal display. User enters commands such as “Show me my transportation expenses for last month,” “Change the date of this receipt to Oct. 1, 2023,” or “Which of my expenses can I deduct for tax purposes?” Terminal records the text, optionally performs local language normalization, and transmits the text message to the server via the communication application.

Input: user-entered natural-language text or speech transcribed to text.

Output: network messages containing natural-language instructions or questions addressed to the server.

### Step 10:

Server analyzes user intent with the generative AI model using a prompt sentence.

Server receives the user's natural-language message and assembles contextual data such as current user identifier, relevant document identifiers, and current view state. Server constructs a prompt sentence that instructs the generative AI model to interpret the user's request and output a structured operation description. For example, server generates: “Interpret the following user request and output the operation to perform in a structured form (operation type, filters, new values). Request: ‘Change the date of this receipt to Oct. 1, 2023.’ Context: receipt identifier 8472, current date 2023 Sep. 30.”

Server sends the resulting prompt sentence to the generative AI model and receives a textual or structured response that encodes an operation such as updating a field in a database record.

Server parses this response into explicit parameters (operation type, target identifiers, new values).

Input: user natural-language message and contextual information.

Output: structured operation description derived from the generative AI model's response.

### Step 11:

Server executes backend operations based on the inferred intent.

Server uses the structured operation description to construct appropriate database commands. For a correction request, server issues an update statement that changes the stored date value for the specified receipt record. For a retrieval request, server generates and executes a query that filters records by category and time period. Server logs each operation for audit purposes, including user identifier, timestamp, and changes applied. Server assembles query results into a structured response object suitable for presentation, such as a list of expenses with dates, amounts, and categories.

Input: structured operation description specifying operations such as search, correction, or reclassification.

Output: modified database records for update operations or retrieved result sets for search operations, along with operation logs.

### Step 12:

Server performs emotion analysis and adjusts explanatory prompts.

Server inspects the text of the user's message and sends it to an emotion analysis model, which returns an emotion label such as “confused,” “frustrated,” or “neutral.” Server attaches this label to the user session and conditions the next prompt sentence to the generative AI model. For example, if confusion is detected, server generates a prompt sentence such as: “The user appears confused. Provide a detailed, step-by-step explanation with minimal technical jargon of the following tax return draft.”

Server sends this prompt together with relevant data to the generative AI model and receives a correspondingly detailed explanation.

Input: user message text and previous interaction state.

Output: emotion label for the user and modified prompt sentences that encode explanation style directives.

### Step 13:

Server generates and transmits response messages and document previews.

Server formats explanations, summaries, and confirmations produced by the generative AI model and by internal aggregation modules into response messages. Server may include links or identifiers to specific receipts, journal entries, or tax-return sections. Server transmits these messages and document previews to the terminal via the communication application.

Terminal receives and renders the content on the display, enabling the user to review and approve or request further changes.

Input: explanation text, query results, and formatted document structures generated by previous steps.

Output: outbound response messages and document previews delivered to the terminal.

### Step 14:

User approves finalized accounting and tax-return data.

User examines the presented draft tax return and accounting summaries and decides whether they are acceptable. User enters an approval message such as “Everything looks correct. Please finalize the return.” Terminal sends this approval message to the server.

Input: user approval or rejection messages entered on the terminal.

Output: network messages containing explicit approval information transmitted to the server.

### Step 15:

Server records finalization status and restricts further modifications.

Server receives the user's approval and updates status fields associated with the tax-return draft and accounting records to mark them as finalized. Server may set flags that prevent modifications by normal update operations and require special authorization for any subsequent changes. Server records a finalization timestamp and user identifier in an audit log. Server optionally generates a final export file or submission-ready document based on the finalized data, and stores it for later retrieval or external submission.

Input: approval information received from the user and identifiers of associated accounting and tax-return records.

Output: updated database records marked as finalized, audit log entries, and optionally generated final documents ready for submission or archival.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

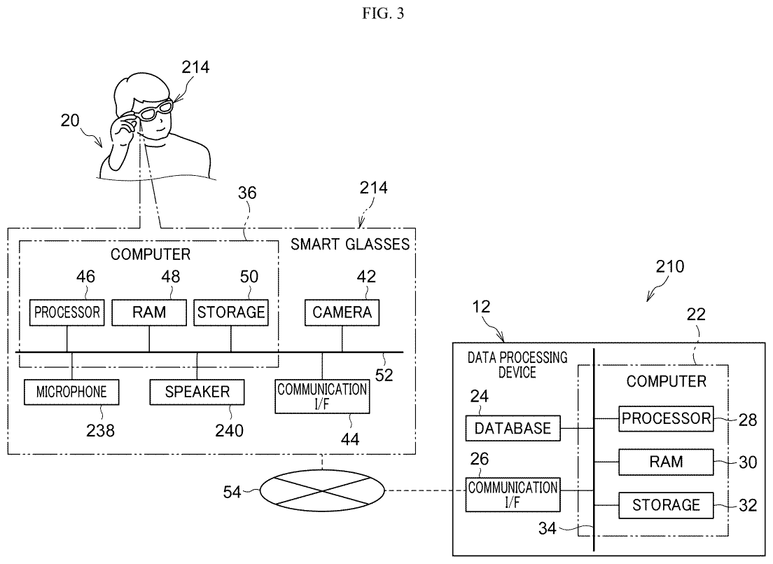

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

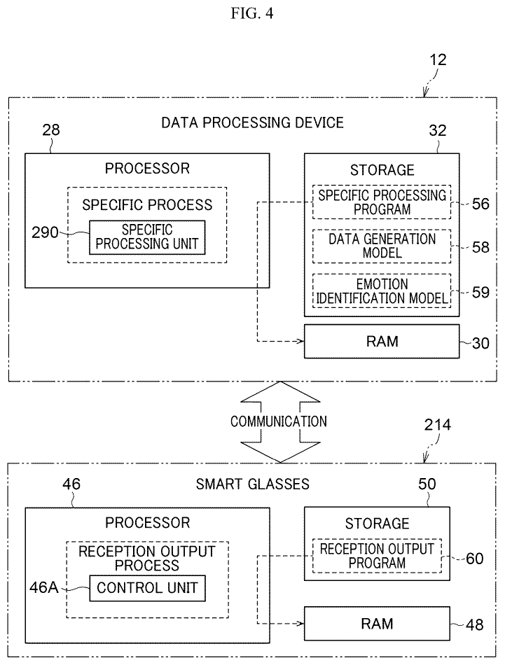

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

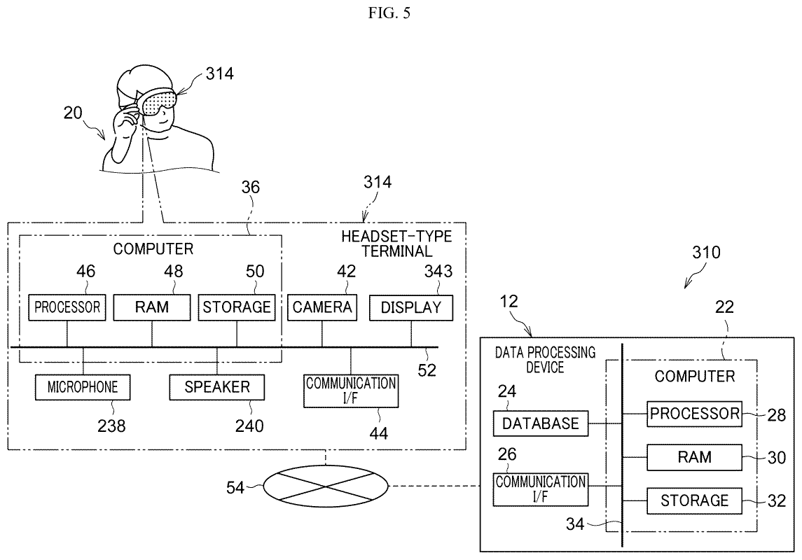

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

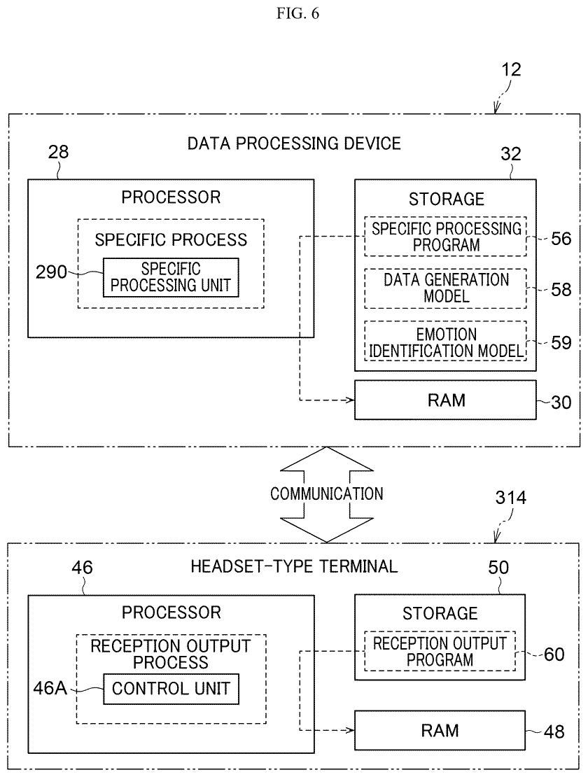

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

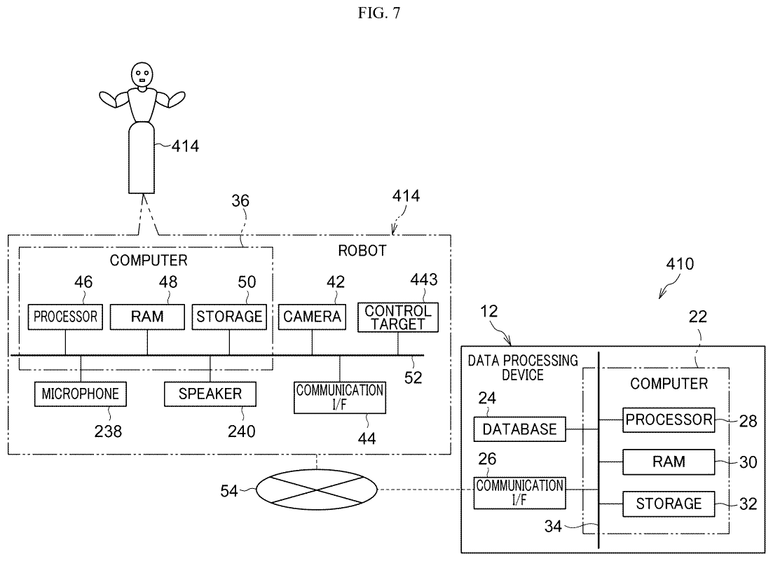

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

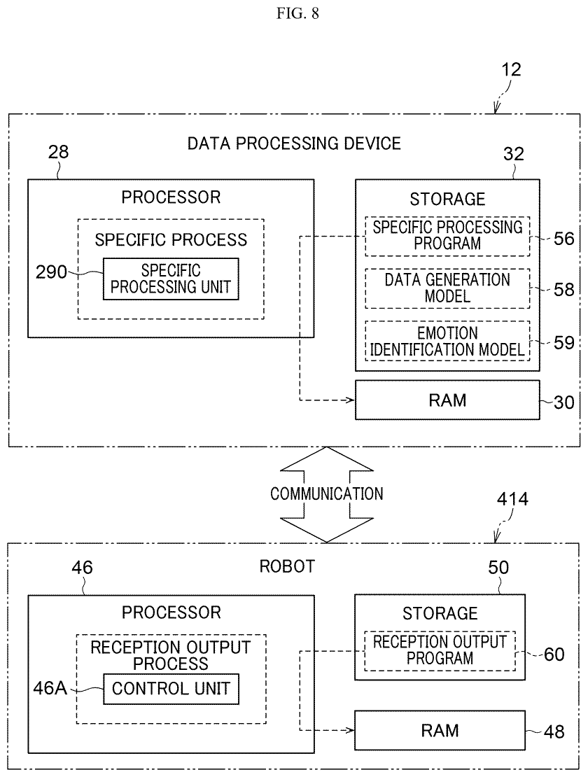

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

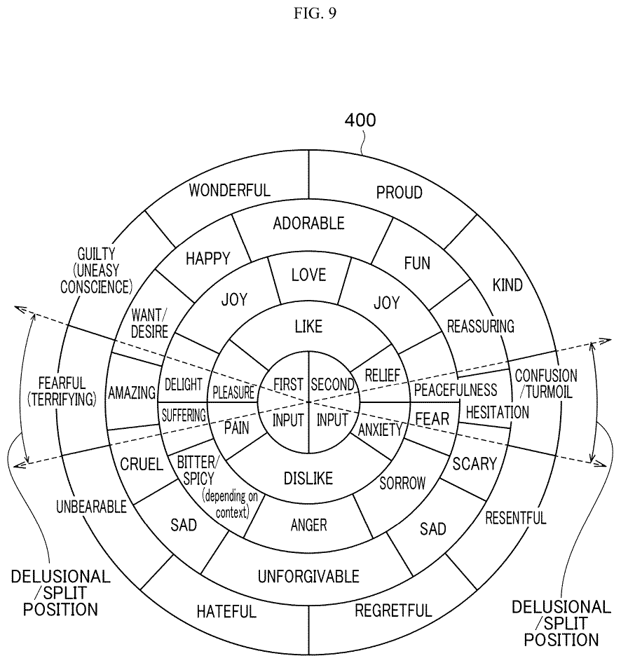

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles.

Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

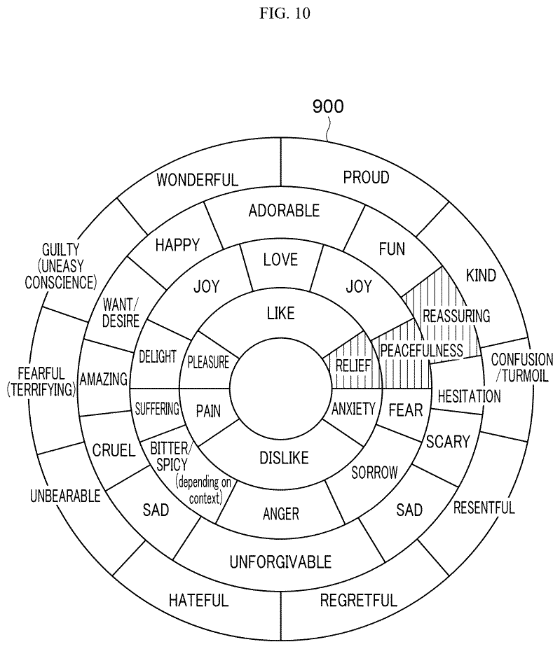

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive image information of an information recording medium via a communication processing device,
perform preprocessing on the image information by using an image processing technique including noise removal, resolution adjustment, density correction, binarization, and geometric correction,
extract character information from the preprocessed image information by using a character recognition technique, and perform verification processing on the character information including format determination, numerical value determination, date determination, and misrecognition correction,
generate structured information indicating at least a transaction date, a transaction amount, a transaction counterpart, a transaction content, and a tax category on the basis of the character information after the verification processing,
generate a prompt sentence for instructing a generative information processing model to automatically generate accounting information including at least an account classification, a debit classification, a credit classification, and an amount on the basis of the structured information and accounting rule information,
input the prompt sentence and the structured information into the generative information processing model and acquire, from the generative information processing model, accounting data including accounting journal information and correction history information associated with the accounting journal information,
store the accounting data in an information management device and convert the accounting data into declaration data corresponding to a taxation procedure format while maintaining consistency by transaction control, and
record, as identification information, a correspondence among the accounting data, the image information of the information recording medium, and the prompt sentence, and enable, in subsequent inquiry or correction processing, acquisition of the accounting data, the image information, and the prompt sentence in association with one another on the basis of the identification information.

### (Supplementary 2)

The system according to supplementary 1,
wherein the processor is configured to
provide an interactive input/output unit for a user to input instruction information in a natural language, analyze the instruction information by using a natural language processing technique to convert the instruction information into control information indicating a search condition or a correction condition for the accounting data, and generate, on the basis of the control information and explanation information including the accounting data, a prompt sentence for causing the generative information processing model to execute automatic searching and automatic correction of the accounting data, and input the prompt sentence into the generative information processing model.

### (Supplementary 3)

The system according to supplementary 1,
wherein the processor is configured to
generate, by using explanation information including the accounting data, the declaration data, and inquiry information in a natural language from a user, a prompt sentence for instructing the generative information processing model to perform cooperation processing with an external knowledge processing device so that the generative information processing model cooperates with the external knowledge processing device to generate advice information on the basis of the accounting data and the declaration data, and input the prompt sentence into the generative information processing model.

### Application Example 1

### (Supplementary 1)

A system comprising a processor,
wherein the processor is configured to
receive, via a communication application, image data representing transaction evidence information transmitted from a terminal having a communication function,
perform preprocessing on the image data using an image processing technique, the preprocessing including at least one of resolution correction, noise reduction, contrast correction, binarization, distortion correction, and region extraction, extract text information from the preprocessed image data by using a character recognition technique,
generate structured data including at least a transaction date, an amount, a transaction entity, and a transaction type on the basis of the text information, and perform a classification process for estimating an expense category on the basis of the structured data,
generate a prompt sentence including the structured data and a result of the classification process and describing content for causing a generative artificial intelligence model to execute accounting processing or tax processing, and input the prompt sentence to the generative artificial intelligence model,
generate accounting data including journal information, expense category information, and tax return information on the basis of a response output from the generative artificial intelligence model,
convert the accounting data into a data format compatible with an external accounting processing information service, transmit the accounting data to the external accounting processing information service via a communication interface, and store the accounting data in a storage device for recording,
convert the accounting data stored in the storage device for recording into a data structure corresponding to a format of a tax return form and output the converted data as tax return data,
control, in the terminal, an imaging device in response to detection of a settlement event so as to automatically capture the image data of the transaction evidence information, and transmit the image data to the system via the communication application, and
receive, via the communication application, a natural language inquiry or correction request transmitted from the terminal or a user, generate an additional prompt sentence including the natural language data and the accounting data and describing content for causing the generative artificial intelligence model to instruct correction, deletion, aggregation, or confirmation of the accounting data, input the additional prompt sentence to the generative artificial intelligence model, update the accounting data on the basis of a response obtained from the generative artificial intelligence model, and notify a result of the update to the terminal via the communication application.

### (Supplementary 2)

The system according to supplementary 1,
wherein the processor is configured to
include, in the prompt sentence to be input to the generative artificial intelligence model, a list of accounting data relating to a plurality of transactions associated with the user, operation types permitted for the accounting data, and constraint conditions defining an output format, obtain, from the generative artificial intelligence model, instruction information in a machine-readable format for specifying an update target and update content of the accounting data, and automatically execute a correction process on the accounting data on the basis of the instruction information.

### (Supplementary 3)

The system according to supplementary 1,
wherein the processor is configured to
include, in the prompt sentence to be input to the generative artificial intelligence model, the accounting data, the tax return data, and cooperation conditions with an external information processing apparatus that performs expert judgment, obtain, from the generative artificial intelligence model, advice information or confirmation results based on the accounting data and the tax return data, present the advice information or the confirmation results to the terminal via the communication application, and update, when necessary, the accounting data and the tax return data.

### Example 2

### (Supplementary 1)

A system comprising a processor,
wherein the processor is configured to
receive, via a communication apparatus, voucher images for tax processing, and perform preprocessing on the voucher images including pixel conversion processing and quality correction processing; and
perform character recognition processing on the preprocessed voucher images to extract character information included in the voucher images as text data, and normalize the text data; and
generate a prompt sentence including an instruction statement that specifies items of an income declaration data structure and the normalized text data, and input the prompt sentence to a generative AI model so as to cause the generative AI model to convert the text data into structured data in a tax declaration format; and
analyze structured data output from the generative AI model, verify a numerical format and a date format in the structured data, record the structured data in a database, and convert the structured data into form data corresponding to a predetermined tax declaration form; and transmit, in response to a request from a user terminal, the structured data or the form data to the user terminal and provide the structured data or the form data as data for display and confirmation on the user terminal; and
generate a prompt sentence including a correction instruction in natural language received from the user terminal and the structured data, and input the prompt sentence to the generative AI model so as to cause the generative AI model to generate updated structured data in which only part of items of the structured data are updated based on the correction instruction, and update the database with the updated structured data; and
generate final declaration data including an electronic submission data format or an image document format based on the updated structured data, and provide the final declaration data to the user terminal.

### (Supplementary 2)

The system according to supplementary 1,
wherein the processor is configured to
provide, via the communication apparatus, an interactive screen for natural language input to the user terminal, analyze a confirmation instruction or a correction instruction in natural language acquired from the user terminal by using natural language processing, generate a prompt sentence including an analysis result and the structured data, and input the prompt sentence to the generative AI model so as to cause the generative AI model to perform automatic correction and completion of the structured data.

### (Supplementary 3)

The system according to supplementary 1,
wherein the processor is configured to
generate a prompt sentence that instructs the generative AI model to collaborate with an external knowledge provision apparatus or an external decision support apparatus to generate advisory information based on the structured data, input the prompt sentence to the generative AI model to acquire the advisory information, and provide the advisory information to the user terminal.

### Application Example 2

### (Supplementary 1)

A system comprising a processor,
wherein the processor is configured to
receive, via a communication apparatus, image information including transaction-related information or structured information, and perform preprocessing on the image information by using an image processing method,
extract character information from the preprocessed image information by using a character recognition method, and generate structured data including date-time information, amount information, transaction party information, and item information by applying a natural language processing method to the character information and the structured information,
generate a prompt sentence including content of accounting processing or tax processing, rule information to be applied, and output format information based on the structured data, and
input the prompt sentence and the structured data to a generative information processing model to cause the generative information processing model to generate accounting data including journal information, expense category information, or declaration information, store the generated accounting data in a storage device and automatically convert the accounting data into a tax return format or an expense management format,
aggregate the accounting data or the declaration information to generate a draft of a tax return document or a draft of an accounting report corresponding to a target period,
receive an instruction or an inquiry in a natural language from a user terminal, use the natural language as a prompt sentence for the generative information processing model to analyze user intent, and execute, based on a result of the analysis, processing of searching, correcting, or reclassifying with respect to the accounting data or the draft of the tax return document, apply an emotion analysis method to text information or voice information in the natural language to identify an emotional state of a user, add additional information including the emotional state to a prompt sentence for the generative information processing model, and
generate a response message in which a detail level and an expression format of explanation information or advice information are controlled according to the emotional state, and transmit the response message and the draft of the tax return document or the draft of the accounting report to the user terminal, and record the draft of the tax return document or the draft of the accounting report as finalized data based on approval information from the user,
wherein the processor is configured to perform all of the above.

### (Supplementary 2)

The system according to supplementary 1,
wherein the processor is configured to
dynamically generate, based on context information including at least one of an instruction sentence or a question sentence in a natural language transmitted from the user terminal and the accounting data stored in the storage device, a prompt sentence to be input to the generative information processing model, and, by causing the generative information processing model to execute an intent analysis process and an inference process related to accounting processing by using the prompt sentence, perform at least one of automatic correction, reclassification, or summarized display of the accounting data.

### (Supplementary 3)

The system according to supplementary 1,
wherein the processor is configured to
generate a prompt sentence that instructs the generative information processing model to generate advice information by using information including the accounting data and the draft of the tax return document, and rule information or guideline information acquired from a knowledge processing apparatus, input the prompt sentence to the generative information processing model, and provide, to the user terminal, professional advice information regarding tax treatment or accounting treatment.

What is claimed is:

1. A system comprising:
circuitry configured to:
receive, via a communication interface coupled to a packet-switched network, image information of an information recording medium from a terminal device, and perform image preprocessing on the image information using image processing operations including noise removal, resolution adjustment, density correction, binarization, and geometric correction;
extract character information from the preprocessed image information using a character recognition technique, and perform verification processing on the character information including format determination, numerical value determination, date determination, and misrecognition correction;
generate structured information records from the verified character information, wherein each structured information record comprises fields for at least a date value, an amount value, a counterpart identifier, a content description, and a category code;
generate a prompt sentence for instructing a generative neural network model to generate classification data including account classification, debit classification, credit classification, and amount based on the structured information records and classification rule information stored in a storage device, operate the generative neural network model using the prompt sentence and the structured information records to acquire classification data and associated correction history information, and store the classification data in the storage device; and
convert the stored classification data into declaration data in a taxation procedure format using a transaction control procedure that maintains referential consistency, and record a correspondence among the classification data, the image information, and the prompt sentence as identification information in the storage device.

2. The system according to claim 1, wherein the circuitry is configured to perform the image preprocessing by applying a denoising filter to reduce image noise, resampling the image to a target resolution, applying a global intensity normalization function to correct density variations, computing a binarization threshold using an adaptive thresholding algorithm, and applying a perspective correction transformation to normalize geometric distortion.

3. The system according to claim 2, wherein the circuitry is configured to perform the character recognition technique by applying an optical character recognition model trained on document character sets to the preprocessed image information, segmenting the image into character bounding boxes, computing recognition confidence scores for each character, and assembling the recognized characters into a structured text string.

4. The system according to claim 3, wherein the circuitry is configured to perform the verification processing by applying format validation rules to detected field values including checking date field syntax, verifying numerical value ranges, and applying a misrecognition correction function that substitutes commonly misrecognized character pairs based on a substitution table stored in the storage device.

5. The system according to claim 1, wherein the circuitry is configured to generate the prompt sentence by assembling segments comprising the structured information records formatted as a structured text representation, the classification rule information specifying account classification conditions, and an instruction directing the generative neural network model to output classification data in a defined schema format.

6. The system according to claim 5, wherein the circuitry is configured to operate the generative neural network model by applying constrained output decoding that validates generated classification data against a schema defining allowable account classification values, debit and credit classification constraints, and amount format requirements, and rejecting and regenerating output that fails schema validation.

7. The system according to claim 6, wherein the circuitry is configured to store the acquired correction history information in the storage device in association with the corresponding classification data record and the prompt sentence, and use the correction history information as additional context in a subsequent prompt sentence when regenerating classification data for the same information recording medium.

8. The system according to claim 1, wherein the circuitry is configured to convert the stored classification data into declaration data by applying a format transformation procedure that maps classification data fields to taxation procedure format fields, applies transaction aggregation rules to combine multiple records within a reporting period, and verifies referential consistency between the classification data records and the aggregated totals using transaction control checks.

9. The system according to claim 1, wherein the circuitry is configured to receive, from the terminal device via the communication interface, a natural language instruction, apply natural language processing to the instruction to extract a modification intent and target record identifier, generate a modification prompt sentence including the extracted intent, the target classification data record, and a modification instruction, and operate the generative neural network model using the modification prompt sentence to generate modified classification data.

10. The system according to claim 9, wherein the circuitry is configured to apply natural language processing by tokenizing the natural language instruction, performing semantic role labeling to identify an action verb and target field references, mapping the identified action verb and field references to a structured modification operation, and encoding the structured modification operation in the modification prompt sentence.

11. The system according to claim 10, wherein the circuitry is configured to validate the modified classification data generated by the generative neural network model by applying the format validation rules and schema constraints, storing the validated modified classification data in the storage device with an updated correction history record, and updating the declaration data to reflect the modification.

12. The system according to claim 1, wherein the circuitry is configured to query an external expert information processing apparatus via the communication interface using the stored classification data and identification information as query parameters, retrieve advisory information from the external expert information processing apparatus, and generate an expert advice prompt sentence incorporating the advisory information and the classification data.

13. The system according to claim 12, wherein the circuitry is configured to operate the generative neural network model using the expert advice prompt sentence to generate an advisory response, and transmit the advisory response to the terminal device via the communication interface.

14. The system according to claim 1, wherein the circuitry is configured to store the image information, the structured information records, the classification data, the correction history information, and the prompt sentence as a transaction record in the storage device with a transaction record identifier, and enable retrieval of prior transaction records by querying the storage device using the transaction record identifier or structured information record field values.

15. The system according to claim 14, wherein the circuitry is configured to detect a duplicate transaction by computing a similarity score between a newly generated structured information record and prior structured information records retrieved from the storage device, and generating a duplicate detection alert when the similarity score exceeds a duplication threshold.

16. The system according to claim 1, wherein the circuitry is configured to receive image information from a plurality of terminal devices concurrently via the communication interface, assign a processing queue entry to each received image information item, and process the queue entries in parallel by instantiating separate image preprocessing, character recognition, and classification data generation operations for each queue entry.

17. The system according to claim 16, wherein the circuitry is configured to detect an error condition during character recognition or verification processing for a queue entry, store the image information and partial results in the storage device with an error status indicator, and transmit an error notification to the corresponding terminal device via the communication interface specifying the detected error type.

18. A system comprising:
circuitry configured to:
receive, via a communication interface coupled to a packet-switched network, image information of an information recording medium from a terminal device, and perform image preprocessing including noise removal by denoising filter, resolution resampling, density normalization, adaptive binarization, and perspective correction;
apply an optical character recognition model to the preprocessed image information to extract character information, and perform verification processing including format validation, numerical range checking, and misrecognition correction using a substitution table to generate verified character information;
generate structured information records from the verified character information comprising date, amount, counterpart identifier, content description, and category code fields;
generate a prompt sentence assembling the structured information records, classification rule information, and an output schema instruction, operate a generative neural network model using the prompt sentence with constrained output decoding to generate classification data comprising account classification, debit classification, credit classification, and amount, and store the classification data with associated correction history information in a storage device;
convert the stored classification data into declaration data in a taxation procedure format using transaction aggregation rules and referential consistency checks; and
receive a natural language modification instruction from the terminal device, apply natural language processing to extract a modification intent and target record identifier, and operate the generative neural network model with a modification prompt sentence to generate modified classification data validated against schema constraints.

19. The system according to claim 18, wherein the circuitry is configured to record a correspondence among the classification data, the image information, and the prompt sentence as identification information in the storage device, and enable retrieval of transaction records by querying the storage device using the identification information or structured information record field values.

20. A method comprising:
receiving, via a communication interface coupled to a packet-switched network, image information of an information recording medium from a terminal device, and performing image preprocessing on the image information using image processing operations including noise removal, resolution adjustment, density correction, binarization, and geometric correction;
extracting character information from the preprocessed image information using a character recognition technique, and performing verification processing on the character information including format determination, numerical value determination, date determination, and misrecognition correction;
generating structured information records from the verified character information, wherein each structured information record comprises fields for at least a date value, an amount value, a counterpart identifier, a content description, and a category code;
generating a prompt sentence for instructing a generative neural network model to generate classification data based on the structured information records and classification rule information stored in a storage device, operating the generative neural network model using the prompt sentence and the structured information records to acquire classification data and associated correction history information, and storing the classification data in the storage device; and
converting the stored classification data into declaration data in a taxation procedure format using a transaction control procedure that maintains referential consistency, and recording a correspondence among the classification data, the image information, and the prompt sentence as identification information in the storage device.
